(19) United States
(12) Patent Application Publication
(10) Pub. No.: US 2026/0152353 A1
(43) Pub. Date: Jun. 4, 2026

(54) Loading Process of a Conveyor Apparatus and Associated Loading Station

(71) Applicant: GHS Technologies GmbH, Hergiswil (CH)

(72) Inventor: Franco CARMAGNOLA, Romentino (NO) (IT)

(21) Appl. No.: 19/339,019

(22) Filed: Sep. 24, 2025

(30) Foreign Application Priority Data
Dec. 2, 2024 (CH) CH001315/2024
Dec. 2, 2024 (IT) 102024000027240

(51) Int. Cl. B65G 47/71; B65G 43/08

(52) U.S. Cl. CPC B65G 47/715; B65G 43/08; B65G 2203/0216; B65G 2203/0233; B65G 2203/025; B65G 2203/0258

(57) ABSTRACT

Process (P) for a loading of objects (A1-A9) on a conveyor apparatus (200), in particular on a conveyor belt, comprising the following steps:
A) arranging a loading station (1) defining a handling surface (10) operatively associated to the conveyor apparatus (200);
B) loading at least one object (A1-A9) on the handling surface (10);
C) detecting said at least one object on the handling surface (10);
F) defining an insertion trajectory (T1-T3) of each object on the conveyor apparatus (200), each insertion trajectory (T1-T3) being defined in accordance with a condition of the conveyor apparatus and/or with a number of objects present on the handling surface;
G) inserting said at least one object on the conveyor apparatus (200) in accordance with the respective insertion trajectory (T1-T3).

### FIELD OF THE ART

The present disclosure refers to a loading process of a conveyor apparatus, such as for example a conveyor belt. In particular, the present disclosure refers to a process for the loading of objects of various type on said conveyor apparatus.

The present disclosure concerns also a loading station for feeding objects of various type on a conveyor apparatus.

The present disclosure also concerns a computer program suitable for being compiled and executed for the execution of the loading process object of the present disclosure.

### KNOWN ART

In the field of logistics is known the use of conveyor apparatus for handling objects and/or items of various type inside distributing, collection and/or storing places, such as logistics poles and warehouses.

Nowadays, the mainly adopted conveyor systems provide for the use of a multiplicity of conveyor belts arranged according to a branched and hierarchical architecture. Generally speaking, the conveyor systems provide for the confluence of multiple secondary conveyor belts towards a primary conveyor belt. Specifically, the secondary conveyor belts, that define loading lines for objects, are configured to feed the primary conveyor belt with a respective flow of objects and/or items. The primary conveyor belt is then in charge of handling the flow resulting from the sum of the individual flows from the secondary conveyor belts to further locations, wherein individual objects and/or items may undergo an additional processing and/or a further sorting. A typical example of the architecture of a conveyor system of a known type is shown in FIG. 2. Another example of a conveyor system is described in document US10301122B2.

In such technical solutions, the secondary conveyor belts are installed laterally with respect to the primary conveyor belt and have at least their ending section tilted with respect to the longitudinal development direction of the primary conveyor belt. Typical inclination values are 30° and 45°, but it is possible to realize couplings with different inclinations. From the inclination between the secondary conveyor belt and the primary conveyor belt depends the speed at which the objects in the secondary flows must move in order not to cause misalignment problems in the primary flow. In fact, if the loading speed of the secondary flow is not adequate to the inclination, the objects would undergo a rotation in the transition from the secondary conveyor belt to the primary conveyor belt such as to misalign them with respect to the optimal orientation thereof. Sub-optimal or incorrect orientations can cause problems in subsequent processing, for example they can cause gripping problems if manipulator devices, such as automated arms, are used in subsequent stations. On the number of secondary conveyor belts that flow onto the primary conveyor belt also depends the total productivity of the system, measured in terms of items conveyed in time units. Specifically, the maximum productivity of the primary conveyor belt cannot be greater than the sum of the maximum productivity of the secondary conveyor belts flowing therein.

In light of the above, in conveyor systems, coordination between secondary flows plays a crucial role. Specifically, in the branched architectures of conveyor belt systems, it results particularly complex to maintain a high productivity while avoiding misalignment and/or overlapping errors of the items loaded on the main conveyor belt.

In this respect, the accuracy with which items are loaded onto the secondary conveyor belts is fundamental. As an example, the items that compose the secondary flows must be accurately spaced between each other and already pre-oriented in a precise manner, otherwise a drop in productivity and/or alignment of the items that compose the flow on the primary conveyor belt will occur.

Nowadays, due to the structural constraints determined by the topology of conveyor systems, a high productivity cannot always be guaranteed as the loading conditions of secondary conveyors vary dynamically. Specifically, the immutability of the arrangement among the conveyor belts that compose the system poorly adapts to the dynamic loading conditions of the conveyor belts. Even the most sophisticated algorithms for optimising and managing conveyor systems do not guarantee the achievement of a satisfactory productivity and/or of a sufficient alignment quality.

The purpose of the present disclosure is to describe a loading process and a loading station which allow an optimisation of the operational flexibility of devices of a known type and which allow in particular a high productivity and a precise arrangement of objects, even having significantly different dimensions from each other, on a primary conveyor apparatus.

### SUMMARY

In the field of loading objects onto a conveyor apparatus, in particular in the field of loading objects onto a primary conveyor belt, it can happen that the feeding of these objects does not allow to achieve the nominal productivity of the conveyor apparatus and/or that these objects arrive on the conveyor apparatus with a misalignment with respect to the desired orientation.

To this purpose, a process for loading objects onto a conveyor apparatus and a loading station has been conceived, the main aspects thereof are described below. These aspects can be combined with each other and/or with portions of the detailed description or claims.

In accordance with a first independent aspect, it is herein described a process (P) for a loading of objects (A1-A9) on a conveyor apparatus (200), in particular on a conveyor belt, comprising the following steps:
A) arranging a loading station (1) defining a handling surface (10) operatively associated to said conveyor apparatus (200);
B) loading at least one object (A1-A9) on said handling surface (10);
C) detecting said at least one object (A1-A9) on said handling surface (10);
F) defining an insertion trajectory (T1-T3) on said conveyor apparatus (200) of said at least one object (A1-A9), said insertion trajectory (T1-T3) being defined in accordance with a condition of said conveyor apparatus (200) and/or with a number of objects (A1-A9) present on said handling surface (10);
G) inserting said at least one object (A1-A9) on said conveyor apparatus (200) in accordance with said insertion trajectory (T1-T3).

According to a further non-limiting aspect, said step G) comprises said at least one object (A1-A9) on a predefined loading area (200′) of said conveyor apparatus (200).

According to a further non-limiting aspect, said loading area (200′) is movable with respect to said handling surface (10).

According to a further non-limiting aspect, said step G) comprises said at least one object (A1-A9) on said predefined loading area (10) in accordance with said insertion trajectory (T1-T3).

According to a further non-limiting aspect, said step G) comprises moving said at least one object (A1-A9) on said handling surface (10) in accordance with said insertion trajectory (T1-T3) in synchrony with said conveyor apparatus (200) and/or in substantial temporal simultaneity with a handling of said loading area (200′) with respect to said handling surface (10), so that said at least one object (A1-A9) when in substantial correspondence of a peripheral portion of said handling surface (10) is in correspondence of said predefined loading area (200′).

According to a further non-limiting aspect, the process (P) comprises receiving handling electronic data of said predefined loading area (200′) from said conveyor apparatus (200), and said step G) comprises moving said at least one object (A1-A9) on said handling surface (10) in accordance with said insertion trajectory (T1-T3) and in accordance with said handling electronic data.

According to a further non-limiting aspect, the process (P) comprises defining and/or adapting said insertion trajectory (T1-T3) in accordance with said handling electronic data.

According to a further non-limiting aspect, said conveyor apparatus (200), preferably said conveyor belt, comprises at least one predefined division area (200″) flanked by said loading area (200′),
said predefined division area (200″) being configured not to house any object.

According to a further non-limiting aspect, said loading area (200′) is movable with respect to a supporting surface.

According to a further non-limiting aspect, said division area (200″) realizes a space, and/or a discontinuity, between said loading area (200′) and a successive loading area (200′).

According to a further non-limiting aspect, said step G) comprises preventing the insertion of said at least one object (A1-A9) on said division area (200″).

According to a further non-limiting aspect, the process comprises the following step: D) orienting said at least one object (A1-A9) according to a predefined orientation, or maintaining a pre-set orientation of said at least one object (A1-A9).

According to a further non-limiting aspect, said predefined or pre-set orientation is defined along a substantially tilted axis, preferably at least locally substantially orthogonal, with respect to said handling surface (10).

According to a further non-limiting aspect, said insertion trajectory (T1-T3) is defined individually for each object (A1-A9).

According to a further non-limiting aspect, said insertion trajectory (T1-T3) is arbitrarily among a plurality of insertion trajectories (T1-T3) made possible by said handling surface (10).

According to a further non-limiting aspect, said step F) provides that said insertion trajectory (T1-T3) is defined in a customized way for each object (A1-A9). In accordance with said aspect, the insertion trajectories (T1-T3) of two different objects can differ from each other, preferably differ from each other.

In particular, according to a further non-limiting aspect, the process (P) provides:
A) arranging a loading station (1) defining a handling surface (10) operatively associated to said conveyor apparatus (200);
B) loading at least a first and a second object (A1-A9) on said handling surface (10);
C) detecting at least a first and a second object (A1-A9) on said handling surface (10);
F) defining an insertion trajectory (T1-T3) on said conveyor apparatus (200) of said at least a first and a second object (A1-A9), said insertion trajectory (T1-T3) being defined in accordance with a condition of said conveyor apparatus (200) and/or with a number of objects (A1-A9) present on said handling surface (10);
G) inserting said at least a first and a second object (A1-A9) on said conveyor apparatus (200) in accordance with said insertion trajectory (T1-T3),
and said step F) provides that said insertion trajectory (T1-T3) is defined in a customized way for each one between said first object and said second object (A1-A9).

According to a further non-limiting aspect, said step F) provides for, for each object (A1-A9), a definition of an insertion path ending on said insertion trajectory (200). In accordance with said aspect, said insertion path has a respective inclination with respect to a forward direction (V) of said conveyor apparatus (200). Optionally said inclination is adjusted in accordance with a destination position of said at least one object (A1-A9) on said conveyor apparatus (200).

According to a further non-limiting aspect, said step F) provides for, for said at least one object (A1-A9), and optionally for each object (A1-A9), a definition of an insertion speed of said insertion trajectory (T1-T3).

According to a further non-limiting aspect, said insertion speed is defined, for said at least one object (A1-A9), and optionally for each object (A1-A9), in accordance with said inclination of the respective insertion path.

According to a further non-limiting aspect, said insertion speed is defined in a temporally varying way.

According to a further non-limiting aspect, said inclination is temporally varying.

According to a further non-limiting aspect, step F) provides for, for said at least one object (A1-A9), and optionally for each object (A1-A9), a definition of a first insertion speed and of a second insertion speed.

According to a further non-limiting aspect, said first insertion speed is associated and/or present on a first portion of the handling surface (10).

According to a further non-limiting aspect, said second insertion speed is associated and/or present on a second portion of the handling surface (10).

According to a further non-limiting aspect, step F) provides for, for said at least one object (A1-A9), and optionally for each object (A1-A9), a definition of a first inclination and of a second inclination.

According to a further non-limiting aspect, said first inclination is associated and/or present on a first portion of the handling surface (10).

According to a further non-limiting aspect, said second inclination is associated and/or present on a second portion of the handling surface (10).

According to a further non-limiting aspect, said step F) provides for, for said at least one object (A1-A9), and preferably for each object (A1-A9), the definition of an insertion speed crossing a further insertion path of a further object (A1-A9).

According to a further non-limiting aspect, said step G) provides for inserting said at least one object (A1-A9), preferably each object (A1-A9), on said conveyor apparatus (200) in accordance with said insertion path.

According to a further non-limiting aspect, said step G) provides for excluding the collision of said object (A1-A9), preferably of each object (A1-A9), with a further object (A1-A9) the further insertion path thereof crosses the insertion path.

According to a further non-limiting aspect, said insertion speed is defined, for said at least one object (A1-A9) and optionally for each object (A1-A9), in accordance with a handling speed of said predefined loading area (200′).

According to a further non-limiting aspect, said step (A) provides that said handling surface (10) extends away from said conveyor apparatus (200) starting from a proximal end (10′), substantially contiguous with the conveyor apparatus (200), up to a distal end (10″).

According to a further non-limiting aspect, step A) provides that said handling surface (10) extends away from said conveyor apparatus (200) along a loading direction (Y), said loading direction (Y) being tilted, optionally perpendicular, with respect to said forward direction (V) of said conveyor apparatus (200).

According to a further non-limiting aspect, in said step B), said at least one object (A1-A9) is loaded in substantial correspondence of said distal end (10″) of said handling surface (10).

According to a further non-limiting aspect, in said step B), a plurality of objects (A1-A9) can be simultaneously loaded on the handling surface (10).

According to a further non-limiting aspect, said step C) provides for localizing said at least one object (A1-A9) on said handling surface (10). Optionally, step C) provides for calculating a position of said at least one object (A1-A9) in said handling surface (10).

According to a further non-limiting aspect, said step C) provides for detecting said at least one object (A1-A9) on said handling surface (10) by means of a vision system. Optionally, said vision system comprises one or more cameras, according to the extension of the surface to be controlled.

According to a further non-limiting aspect, said step C) provides for recognizing, at least partially, a shape of said at least one object (A1-A9). Optionally, said step C) provides for recognizing the projection of said at least one object (A1-A9) on said handling surface (10).

According to a further non-limiting aspect, said step F) provides for the definition of a plurality of insertion trajectories (T1-T3), one for each object of the plurality of objects (A1-A9). In accordance with said aspect, said plurality of insertion trajectories (T1-T3) differ from each other.

According to a further non-limiting aspect, said plurality of insertion trajectories (T1-T3) have insertion paths different from each other and/or inclinations different from each other and/or insertion speeds different from each other.

According to a further non-limiting aspect, said step F) provides that the insertion trajectory (T1-T3) of each object comprises at least a straight section.

According to a further non-limiting aspect, step F) provides that the insertion trajectory (T1-T3) of each object can comprise at least a curvilinear section.

According to a further non-limiting aspect, said process (P) comprises a step E) of assessing at least one status parameter of said at least one object (A1-A9).

According to a further non-limiting aspect, said step E) provides for the execution of at least one of the following activities:
a measurement of a weight of said at least one object (A1-A9); and/or
a measurement of a volume of said at least one object (A1-A9); and/or
a scanning of an identification code, preferably a bar code, of said at least one object (A1-A9).

According to a further non-limiting aspect, said step D) provides for a rotation of said at least one object (A1-A9) for reaching said predefined orientation. In accordance with said aspect, the rotation of said at least one object (A1-A9) takes place around a respective rotation axis. Optionally, said rotation axis is perpendicular to said handling surface (10).

According to a further non-limiting aspect, said predefined orientation of said at least one object (A1-A9) is determined in accordance with the corresponding projection on said handling surface (10) assessed in said step C). Optionally, said predefined orientation corresponds to an orientation of said at least one object (A1-A9) wherein the relative size of main development is parallel to said loading direction (Y).

According to a further non-limiting aspect, said step A) provides that the handling surface (10) of the loading station (1) is defined at least partially by a plurality of conveyor devices (100) arranged according to a planar matrix. In accordance with said aspect, optionally, said plurality of conveyor devices (100) is homogeneously distributed on at least part of the extension of said handling surface (10).

According to a further non-limiting aspect, each conveyor device of the plurality of conveyor devices (100) is configured to be activated in order to locally control a translation of said at least one object (A1-A9) on the handling surface (10) at least during the execution of step G).

According to a further non-limiting aspect, each conveyor device of the plurality of conveyor devices (100) is configured to be activated in order to locally control a rotation of said at least one object (A1-A9), said rotation taking place around a respective rotation axis, optionally orthogonal to the handling surface (10), at least during the execution of said step D).

According to a further non-limiting aspect, the plurality of conveyor devices (100) is configured to singularize two or more objects (A1-A9) at least partially overlapping and respectively arranged at heights different from each other with respect to the handling surface (10).

According to a further non-limiting aspect, said process (P) comprises the following steps:
F′) defining an extraction trajectory (T1′-T3′) of said at least one object (A1-A9) from said conveyor apparatus (200), preferably from said predefined loading area (200′), said extraction trajectory (T1′-T3′) being preferably defined individually for each object (A1-A9) present on said conveyor apparatus (200), preferably on said predefined loading area (200′), in accordance with said condition of said conveyor apparatus (200) and/or with a number of objects (A1-A9) present on said handling surface (10);
G′) extracting said at least one object (A1-A9) from said conveyor apparatus (200) in accordance with said extraction trajectory (T1′-T3′).

According to a further non-limiting aspect, said step G') comprises extracting said at least one object (A1-A9) from said conveyor apparatus, preferably from said predefined loading area (200′), in synchrony with said conveyor apparatus (200′) and/or in substantial temporal simultaneity with a handling of said predefined loading area (200′) with respect to said handling surface (10), preferably at least when said at least one object (A1-A9), lying on said at least one predefined loading area (200′), is in substantial correspondence with a peripheral portion of said handling surface (10). According to a further non-limiting aspect, said step F′) provides for, for each object (A1-A9), a definition of an extraction path ending on said handling surface (10). In accordance with said aspect, said extraction path has a respective inclination with respect to a forward direction (V) of said conveyor apparatus (200). Optionally said inclination is adjusted in accordance with a destination position of said at least one object (A1-A9) on said handling surface (10).

According to a further non-limiting aspect, said step F′) provides for, for said at least one object (A1-A9), and optionally for each object (A1-A9), a definition of an extraction speed of said extraction trajectory (T1′-T3′).

According to a further non-limiting aspect, said extraction speed is defined, for said at least one object (A1-A9), and optionally for each object (A1-A9), in accordance with said inclination of the respective extraction path.

According to a further non-limiting aspect, said extraction speed is defined in a temporally varying way.

According to a further non-limiting aspect, said inclination is temporally varying. According to a further non-limiting aspect, step F′) provides for, for said at least one object (A1-A9), and optionally for each object (A1-A9), a definition of a first extraction speed and of a second extraction speed.

According to a further non-limiting aspect, said first extraction speed is associated and/or present on a first portion of the handling surface (10).

According to a further non-limiting aspect, said second extraction speed is associated and/or present on a second portion of the handling surface (10).

According to a further non-limiting aspect, step F′) provides for, for said at least one object (A1-A9), and optionally for each object (A1-A9), a definition of a first inclination and of a second inclination.

According to a further non-limiting aspect, said first inclination is associated and/or present on a first portion of the handling surface (10).

According to a further non-limiting aspect, said second inclination is associated and/or present on a second portion of the handling surface (10).

According to a further non-limiting aspect, said step F′) provides for, for said at least one object (A1-A9), and preferably for each object (A1-A9), the definition of an insertion path crossing a further insertion path of a further object (A1-A9).

According to a further non-limiting aspect, said step G′) provides for inserting said at least one object (A1-A9), preferably each object (A1-A9) on said handling surface (10) in accordance with said extraction path.

According to a further non-limiting aspect, said step G′) provides for excluding the collision of said object (A1-A9), preferably of each object (A1-A9), with a further object (A1-A9) the further extraction path thereof crosses the extraction path.

According to a further non-limiting aspect, said process (P) comprises detecting at least one specific conveyor device (100) that is malfunctioning, among the plurality of conveyor devices (100) of the handling surface (10), and comprises defining an auxiliary insertion trajectory, for an insertion of said at least one object (A1-A9) on said conveyor apparatus (200), preferably on said at least one predefined loading area (200′) and/or an auxiliary extraction trajectory, for an extraction of said at least one object (A1-A9) from said conveyor apparatus (200), preferably from said at least one predefined loading area (200′).

According to a further non-limiting aspect, said auxiliary insertion trajectory differs from said insertion trajectory (T1-T3) and/or said auxiliary extraction trajectory differs from said extraction trajectory (T1′-T3′).

According to a further non-limiting aspect, said auxiliary insertion trajectory and/or said auxiliary extraction trajectory excludes said at least one specific conveyor device (100) that is malfunctioning.

In accordance with a further independent aspect, it is also herein described a process for an unloading of objects (A1-A9) from a conveyor apparatus (200), in particular on a conveyor belt, comprising the following steps:
A′) arranging a loading station (1) defining a handling surface (10) for at least one object (A1-A9) to be conveyed;
C′) detecting said at least one object (A1-A9) on the conveyor apparatus (200) optionally on a conveyor belt of said conveyor apparatus (200), preferably on at least a predefined loading area (200′);
F′) calculating an extraction trajectory (T1′-T3′) for defining an extraction path of said at least one object (A1-A9) from said conveyor apparatus (200), optionally from said conveyor belt, preferably from said at least one predefined loading area (200′);
G′) extracting said at least one object (A1-A9) from said conveyor apparatus (200), optionally from said conveyor belt, preferably from said at least one predefined loading area (200′), in accordance with said extraction trajectory (T1′-T3′),
B′) loading said at least one object (A1-A9) on said handling surface (10).

According to a further non-limiting aspect, said step B′) occurs after, optionally immediately after, said step G′).

In particular, according to a further non-limiting aspect, said process comprises:
A′) arranging a loading station (1) defining a handling surface (10) for at least a first and a second object (A1-A9) to be conveyed;
C′) detecting said at least a first and a second object (A1-A9) on the conveyor apparatus (200) optionally on a conveyor belt of said conveyor apparatus (200), preferably on at least a predefined loading area (200′);
F′) calculating an extraction trajectory (T1′-T3′) for defining an extraction path of said at least a first and a second object (A1-A9) from said conveyor apparatus (200), optionally from said conveyor belt, preferably from said at least one predefined loading area (200′);
G′) extracting said at least a first and a second object (A1-A9) from said conveyor apparatus (200), optionally from said conveyor belt, preferably from said at least one predefined loading area (200′), in accordance with said extraction trajectory (T1′-T3′),
B′) loading said at least a first and a second object (A1-A9) on said handling surface (10).

According to a further non-limiting aspect, said step F′) provides for defining, for each one between said first object and said second object (A1-A9), a customized trajectory, preferably wherein said personalized trajectory is defined individually for each one between said first object and said second object (A1-A9) in accordance with a condition of said conveyor apparatus (200) and/or with a number of objects (A1-A9) present on said handling surface.

According to a further non-limiting aspect, said step F′) comprises defining an extraction speed of said extraction trajectory (T1′-T3′), in accordance with a handling speed of said conveyor apparatus (200) with respect to said handling surface (10).

According to a further non-limiting aspect, said step G′) comprises moving said at least one object (A1-A9) on said handling surface (10) in accordance with said extraction trajectory (T1′-T3′) in synchrony with said conveyor apparatus (200) and/or in substantial temporal simultaneity with a handling of said loading area (200′) with respect to said handling surface (10), so that said at least one object (A1-A9) when in substantial correspondence of a peripheral portion of said handling surface (10) is in correspondence of said predefined loading area (200′).

According to a further non-limiting aspect, said process for the unloading of said at least one object (A1-A9) is associated, preferably executed before, and/or after, said process (P) for the loading of said at least one object (A1-A9), optionally of said a first object and of said second object.

In accordance with a further independent aspect, it is also herein described a loading station (1) of at least one object (A1-A9) on a conveyor apparatus (200), in particular on a conveyor belt, configured for the execution of said process (P).

In accordance with a further independent aspect, it is also herein described a loading station (1) for the loading of at least one object (A1-A9) on a conveyor apparatus (200), in particular on a conveyor belt, said loading station (1) defining a handling surface (10) operatively associated to said conveyor apparatus (200), said handling surface (10) comprising:
a loading portion (11) configured to receive said at least one object (A1-A9);
a controlling portion (12) configured to identify said at least one object (A1-A9) on said handling surface (10);
an inserting portion (14) configured to insert said at least one object (A1-A9) on said conveyor apparatus (200) according to an insertion trajectory (T1-T3);
said loading station (1) comprising at least one controlling module (CM), operatively associated at least to said controlling portion (12), said orienting portion (13) and said inserting portion (14); said controlling module (CM) being configured to define said insertion trajectory (T1-T3) in accordance with a condition of said conveyor apparatus (200) and/or with a number of objects (A1-A9) present on the handling surface (10).

According to a further non-limiting aspect, said controlling module (CM) is configured to individually define, for each object (A1-A9), said insertion trajectory (T1-T3) in accordance with said at least one condition of said conveyor apparatus (200) and/or with said number of objects (A1-A9) present on the handling surface (10).

According to a further non-limiting aspect, said controlling module (CM) is configured to cause an insertion of said at least one object (A1-A9) on a predefined loading area (200′) of said conveyor apparatus.

According to a further non-limiting aspect, said controlling module (CM) is configured to prevent an insertion of said at least one object (A1-A9) on said division area (200″).

According to a further non-limiting aspect, said loading area (200′) is movable with respect to said handling surface (10).

According to a further non-limiting aspect, said controlling module (CM) is configured to cause an insertion of said at least one object (A1-A9) on said predefined loading area (200′) in accordance with said insertion trajectory (T1-T3).

According to a further non-limiting aspect, said controlling module (CM) is configured to cause an insertion of said at least one object (A1-A9) on said predefined loading area (200′) in accordance with said insertion trajectory (T1-T3) in synchrony with said conveyor apparatus (200) and/or in substantial temporal simultaneity with a handling of said loading area (200′) with respect to said handling surface (10), so that said at least one object (A1-A9), when in substantial correspondence of a peripheral portion of said handling surface (10), is in correspondence of said predefined loading area (200′).

According to a further non-limiting aspect, said controlling module (CM) is configured to receive handling electronic data of said predefined loading area (200′) from said conveyor apparatus (200), and to cause an insertion of said at least one object (A1-A9) on said predefined loading area (200′) in accordance with said insertion trajectory (T1-T3) and in accordance with said handling electronic data.

According to a further non-limiting aspect, said controlling module (CM) is configured to define and/or adapt said insertion trajectory (T1-T3) in accordance with said handling electronic data.

According to a further non-limiting aspect, said loading station (1) comprises an orienting portion (13) configured to orient said at least one object (A1-A9) according to a predefined orientation or to maintain a pre-set orientation of said at least one object (A1-A9).

According to a further non-limiting aspect, said controlling module (CM) is operatively associated to said orienting portion (13).

According to a further non-limiting aspect, said controlling module (CM) is configured to individually define the insertion trajectory (T1-T3) for each object (A1-A9).

According to a further non-limiting aspect, said controlling module (CM) is configured to allow to select said insertion trajectory (T1-T3) among a plurality of insertion trajectories (T1-T3) made possible by said handling surface (10).

According to a further non-limiting aspect, said controlling module (CM) is configured to define, for said at least one object (A1-A9) and optionally for each object (A1-A9), an insertion speed of said insertion trajectory (T1-T3) on said conveyor apparatus (200), preferably on said predefined loading area (200′).

According to a further non-limiting aspect, said insertion speed is defined, for said at least one object (A1-A9) and optionally for each object (A1-A9), in accordance with said inclination of the respective insertion path.

According to a further non-limiting aspect, said insertion speed is temporally varying.

According to a further non-limiting aspect, said inclination is temporally varying. According to a further non-limiting aspect, said controlling module (CM) is configured to define, for said at least one object (A1-A9) and optionally for each object (A1-A9), at least a first insertion speed and a second insertion speed of said insertion trajectory (T1-T3) on said conveyor apparatus (200), preferably on said predefined loading area (200′).

According to a further non-limiting aspect, said first insertion speed is associated and/or present on a first portion of the handling surface (10).

According to a further non-limiting aspect, said second insertion speed is associated and/or present on a second portion of the handling surface (10).

According to a further non-limiting aspect, said controlling module (CM) is configured to define, for said at least one object (A1-A9) and optionally for each object (A1-A9), at least a first inclination and a second inclination of said insertion trajectory (T1-T3) on said conveyor apparatus (200), preferably on said predefined loading area (200′).

According to a further non-limiting aspect, said first inclination is associated and/or present on a first portion of the handling surface (10).

According to a further non-limiting aspect, said second inclination is associated and/or present on a second portion of the handling surface (10).

According to a further non-limiting aspect, said controlling module (CM) is configured to define, for at least one object (A1-A9) and optionally for each object (A1-A9), an insertion path crossing a further insertion path of a further object (A1-A9).

According to a further non-limiting aspect, said controlling module (CM) is configured to cause an insertion of said at least one object (A1-A9), preferably each object (A1-A9), on said conveyor apparatus (200) in accordance with said insertion path.

According to a further non-limiting aspect, said controlling module (CM) is configured to exclude a collision of said object (A1-A9) preferably of each object (A1-A9), with a further object (A1-A9) the further insertion path thereof crosses the insertion path.

According to a further non-limiting aspect, said insertion speed is defined, for said at least one object (A1-A9) and optionally for each object (A1-A9), in accordance with a handling speed of said predefined loading area (200′).

According to a further non-limiting aspect, said handling surface (10) extends away from said conveyor apparatus (200) starting from a proximal end (10′), substantially contiguous with the conveyor apparatus (200), up to a distal end (10″). In accordance with this aspect, said loading portion (11) comprises said distal end (10″) and said inserting portion (14) comprises said proximal end (10′).

According to a further non-limiting aspect, said handling surface (10) extends away from said conveyor apparatus (200) along a loading direction (Y), said loading direction (Y) being tilted, optionally perpendicular, with respect to a forward direction (V) of said conveyor apparatus (200).

according to a further non-limiting aspect, said controlling module (CM) is configured to define an insertion path ending on said conveyor apparatus (200), said insertion path having a respective inclination with respect to a forward direction (V) of said conveyor apparatus (200), optionally wherein said inclination is adjusted in accordance with a destination position of said at least one object (A1-A9) on said conveyor apparatus (200), preferably in accordance with a destination position of said at least one object (A1-A9) on said conveyor belt, optionally on said loading area (200′).

According to a further non-limiting aspect, said handling surface (10) has a plane polygonal shape.

According to a further non-limiting aspect, said handling surface (10) has the shape of a quadrilateral. Optionally, said handling surface (10) has the shape of a parallelogram. In an embodiment, said handling surface (10) has rectangular shape.

According to a further non-limiting aspect, the loading station (1) comprises at least one controlling sensor (12a), operatively connected to said controlling portion (12) and configured to detect said at least one object (A1-A9) in said controlling portion (12) of said handling surface (10), optionally said at least one controlling sensor (12a) being configured to calculate a position of said at least one object (A1-A9) in said controlling portion (12).

According to a further non-limiting aspect, said at least one controlling sensor (12a) is operatively connected to said controlling module (CM) to send a signal representative of said detecting of said at least one object (A1-A9).

According to a further non-limiting aspect, said at least one controlling sensor (12a) comprises at least one camera operatively active on said controlling portion (12).

According to a further non-limiting aspect, said at least one controlling sensor (12a

) is configured to recognize, at least partially, the shape of each object (A1-A9). Preferably, said at least one controlling sensor (12a) is configured to recognize the projection of said at least one object (A1-A9) in said controlling portion (12).

According to a further non-limiting aspect, said orienting portion (13) is configured to arrange said at least one object (A1-A9) in accordance with said predefined orientation. Preferably, said orienting portion (13) is configured to rotate said at least one object (A1-A9) around a respective rotation axis until the reaching of said predefined orientation. Optionally, said rotation axis is perpendicular to said handling surface (10).

According to a further non-limiting aspect, said predefined orientation of each object (A1-A9) is determined in accordance with the corresponding projection on said handling surface (10) assessed by means of the controlling sensor (12a). Optionally, said predefined orientation corresponds to an orientation of each object (A1-A9) wherein the relative size of main development is parallel to said loading direction (Y).

According to a further non-limiting aspect, said handling surface (10) is defined at least partially by a plurality of conveyor devices (100) arranged according to a planar matrix, optionally said plurality of conveyor devices (100) being homogeneously distributed on at least part of the extension of said handling surface (10).

According to a further non-limiting aspect, each conveyor device of the plurality of conveyor devices (100) is configured to be activated in order to locally control a translation of said at least one object (A1-A9) on the handling surface (10).

According to a further non-limiting aspect, a portion of said plurality of conveyor devices (100) defining said orienting portion (13) is configured to be activated in order to locally control a rotation of said at least one object (A1-A9), said rotation taking place around a respective rotation axis optionally orthogonal to said handling surface (10).

According to a further non-limiting aspect, the plurality of conveyor devices (100) is configured to singularize two or more objects (A1-A9) at least partially overlapping and respectively arranged at heights different from each other with respect to the handling surface (10).

According to a further non-limiting aspect, each conveyor device of the plurality of conveyor devices (100) comprises a supporting element (101) and a head element (102). Preferably, said head element (102) is removably installed on said supporting element (101) and is arranged at a height higher with respect to the height at which the supporting element lies.

According to a further non-limiting aspect, said head element (102) comprises at least a primary translator (103) activatable for translating said at least one object (A1-A9) along at least one translation direction (X).

According to a further non-limiting aspect, said conveyor device (100) comprises also a rotation actuator (104) configured to rotate said head element (102) with respect to said supporting element (101) around said rotation axis Z. Preferably, the activation of the rotation actuator (104) allows to modify the orientation of the translation direction (X) in the handling surface (10).

According to a further non-limiting aspect, said handling surface (10) comprises a weighing portion (15) configured to measure a weight of said at least one object (A1-A9), said weighing portion (15) comprising optionally at least one weight sensor operatively connected to said controlling module (CM).

According to a further non-limiting aspect, said handling surface (10) comprises a volume assessment portion (16) configured to measure a volume of said at least one object (A1-A9), said volume assessment portion (16) comprising optionally at least one optical sensor operatively connected to said controlling module (CM).

According to a further non-limiting aspect, said handling surface (10) comprises a reading portion (17) configured for a scanning of at least one identification code of said at least one object (A1-A9), said reading portion (17) comprising optionally at least one optical reader operatively connected to said controlling module (CM).

According to a further non-limiting aspect, the loading portion (11) is configured to receive substantially simultaneously a plurality of objects (A1-A9).

According to a further non-limiting aspect, the controlling portion (12) is configured to identify substantially simultaneously said plurality of objects (A1-A9) on said handling surface (10).

According to a further non-limiting aspect, the orienting portion (13) is configured to orient substantially simultaneously the plurality of objects in accordance with respective predefined orientations.

According to a further non-limiting aspect, the inserting portion (14) is configured to substantially simultaneously insert said plurality of objects (A1-A9) on said conveyor apparatus (200) according to a plurality of insertion trajectories (T1-T3), each insertion trajectory of said plurality of insertion trajectories (T1-T3) being calculated by said controlling module (CM) in a customized way for each object of the plurality of objects (A1-A9) in accordance with the condition of said conveyor apparatus (200) and/or with the number of objects (A1-A9) present on the handling surface (10).

According to a further non-limiting aspect, the loading station (1) comprises a surveillance module (18) operatively connected to said conveyor apparatus (200) and to said controlling module (CM). Said surveillance module (18) is configured to monitor the condition of said conveyor apparatus (200) upwards of the loading station (1). Optionally, said surveillance module (18) is configured to analyse the arrangement of the objects eventually already present on the conveyor apparatus (200) so as to detect free spaces in which inserting objects (A1-A9) present on the handling surface (10) and allow the calculation of said at least one insertion trajectory (T1-T3).

According to a non-limiting aspect, said controlling module (CM) comprises a memory device (M) configured to house a computer program.

According to a further non-limiting aspect, said controlling module (CM) comprises a processing unit (CPU) configured to compile and execute said computer program for the execution of the steps of the process (P) of loading by means of said loading station (1).

According to a further non-limiting aspect, said loading station (1) is configured also to execute an unloading of said at least one object (A1-A9) from said conveyor apparatus (200).

According to a further non-limiting aspect, said inserting portion (14) is also configured to receive said at least one object (A1-A9) from said conveyor apparatus (200) and to introduce it in handling on said handling surface (10) according to a respective extraction trajectory (T1′-T3′).

According to a further non-limiting aspect, said controlling module (CM) is configured to define said extraction trajectory (T1′-T3′) in accordance with a condition of said conveyor apparatus (200) and/or with a number of objects (A1-A9) present on the handling surface (10).

According to a further non-limiting aspect, said controlling module (CM) is configured to cause an extraction of said at least one object (A1-A9) from said predefined loading area (200′) in accordance with said extraction trajectory (T1′-T3′) in synchrony with said conveyor apparatus (200) and/or in substantial temporal simultaneity with a handling of said loading area (200′) with respect to said handling surface (10), preferably when said at least one object (A1-A9), lying on said predefined loading area (200′), lies in substantial correspondence of a peripheral portion of said handling surface (10).

According to a further non-limiting aspect, said controlling module (CM) is configured to cause said extraction of said at least one object in accordance with an extraction path ending on said handling surface (10).

According to a further non-limiting aspect, said controlling module (CM) is configured to define an extraction speed and/or an inclination of said extraction trajectory (T1′-T3′).

According to a further non-limiting aspect, said extraction speed is defined, for said at least one object (A1-A9), and optionally for each object (A1-A9), in accordance with said inclination of the respective extraction path.

According to a further non-limiting aspect, said extraction speed is temporally varying.

According to a further non-limiting aspect, said inclination is temporally varying.

According to a further non-limiting aspect, said controlling module (CM) is configured to define, for said at least one object (A1-A9) and optionally for each object (A1-A9), at least a first extraction speed and a second extraction speed of said extraction trajectory (T1′-T3′) on said conveyor apparatus (200), preferably on said predefined loading area (200′).

According to a further non-limiting aspect, said first extraction speed is associated and/or present on a first portion of the handling surface (10).

According to a further non-limiting aspect, said second extraction speed is associated and/or present on a second portion of the handling surface (10).

According to a further non-limiting aspect, said controlling module (CM) is configured to define, for said at least one object (A1-A9) and optionally for each object (A1-A9), at least a first inclination and a second inclination of said extraction trajectory (T1′-T3′) on said conveyor apparatus (200), preferably on said predefined loading area (200′).

According to a further non-limiting aspect, said first inclination is associated and/or present on a first portion of the handling surface (10).

According to a further non-limiting aspect, said second inclination is associated and/or present on a second portion of the handling surface (10).

According to a further non-limiting aspect, said controlling module (CM) is configured to define, for said at least one object (A1-A9) and optionally for each object (A1-A9), an extraction path crossing a further extraction path of a further object (A1-A9).

According to a further non-limiting aspect, said controlling module (CM) is configured to cause an extraction of said at least one object (A1-A9), preferably each object (A1-A9), from said conveyor apparatus (200) in accordance with said extraction path.

According to a further non-limiting aspect, said controlling module (CM) is configured to exclude a collision of said object (A1-A9) preferably of each object (A1-A9), with a further object (A1-A9) the further extraction path thereof crosses the extraction path.

According to a further non-limiting aspect, the loading station (1) is configured to detect at least one specific conveyor device (100) that is malfunctioning, among the plurality of conveyor devices (100) of the handling surface (10), and said controlling module (CM) is configured to define an auxiliary insertion trajectory, for an insertion of said at least one object (A1-A9) on said conveyor apparatus (200), preferably on said at least one predefined loading area (200′) and/or an auxiliary extraction trajectory, for an extraction of said at least one object (A1-A9) from said conveyor apparatus (200), preferably from said at least one predefined loading area (200′).

In accordance with a further independent aspect, it is also herein described a computer program configured to be stored on a memory device (M) and to be executed by a processing unit (CPU) to execute the steps of the process (P) according to one or more of the aspects herein described, preferably by means of the loading station (1) according to one or more of the aspects here described.

According to a further non-limiting aspect, said computer program comprises a plurality of instructions suitable for being compiled and executed in sequence for the execution of said process (P) by means of said loading station (1).

According to a further non-limiting aspect, said computer program comprises a plurality of code portions, each portion comprising a plurality of instructions suitable for being compiled for the execution of one of the steps of the process (P) of loading by means of said loading station (1).

According to a further non-limiting aspect, said computer program comprises at least one self-learning algorithm, also called machine learning algorithm. Optionally, said computer program comprises at least a supervised machine learning algorithm. Still optionally, said computer program comprises at least an online machine learning algorithm.

According to a further independent aspect, it is also herein described a conveyor system comprising:
a conveyor apparatus (200), in particular a conveyor belt, configured to receive at least one object (A1-A9) and handle it in accordance with a forward direction (V);
the loading station (1) in accordance with one or more of the aspects herein described, said loading station (1) being operatively associated to said conveyor apparatus (200) for loading said at least one object (A1-A9).

According to a further non-limiting aspect, said conveyor apparatus (200), in particular said conveyor belt, comprises at least one predefined loading area (200′) for the loading of said at least one object.

According to a further non-limiting aspect, said conveyor apparatus (200), in particular said conveyor belt, comprises:
a first predefined loading area (200′) for the loading of a first object;
a second predefined loading area (200′), for the loading of a second object;
at least a predefined division area (200″) interposed between said first predefined loading area (200′) and said second predefined loading area (200′), said predefined division area (200″) being configured not to house any object, optionally not to house any between said first object and said second object.

According to a further non-limiting aspect, said conveyor apparatus (200), in particular said conveyor belt, is movable with respect to said loading station (1), in particular with respect to said handling surface (10) of said loading station (1).

According to a further non-limiting aspect, said loading area (200′) comprises a supporting surface.

According to a further non-limiting aspect, said division area (200″) realizes a space, and/or a discontinuity, between said first predefined loading area and said second predefined loading area.

### FIGURES

The following detailed description concerns some preferred embodiments of the object of the present disclosure. The detailed description refers to the attached figures, a short description thereof is hereinafter indicated.

FIG. 1 shows by means of a schematic form the steps of a loading process of at least one object on a conveyor apparatus according to the present disclosure;

FIG. 2 shows a conveyor system of known type provided with a pair of loading stations associated to a conveyor apparatus;

FIG. 3 shows a plan view from above of a loading station, shown in a first exemplary embodiment according to the present disclosure. The loading station is represented associated to a conveyor apparatus, specifically a conveyor belt, in the context of a conveyor system, and is shown in the execution of the steps of the process of loading of FIG. 1;

FIG. 4 shows a plan view from above of the loading station of FIG. 3 in the execution of the second step of the process of loading of FIG. 1. With respect to FIG. 3, the loading station is represented as housing simultaneously three objects;

FIG. 5 shows a plan view from above of the loading station of FIG. 3 in the execution of the third step of the process of loading of FIG. 1, subsequent to the step shown in FIG. 4;

FIG. 6 shows a plan view from above of the loading station of FIG. 3 in the execution of the fourth step of the process of loading of FIG. 1, subsequent to the step shown in FIG. 5;

FIG. 7 shows a plan view from above of the loading station of FIG. 3 in the execution of the penultimate step of the process of loading of FIG. 1, subsequent to the step shown in FIG. 6;

FIG. 7a and FIG. 7b show a step of forwarding of a predetermined loading area of an object, and the evolution of the trajectory of the object on the handling surface, towards the loading area of the object;

FIG. 8 shows a plan view from above of the loading station of FIG. 3 in the execution of the last step of the process of loading of FIG. 1, subsequent to the step shown in FIG. 7;

FIG. 9 shows a plan view from above of a loading station, shown in a second exemplary embodiment according to the present disclosure;

FIG. 10 shows a plan view from above of a loading station, shown in a third exemplary embodiment according to the present disclosure;

FIG. 11 shows a plan view from above of a loading station, shown in a fourth exemplary embodiment according to the present disclosure;

FIG. 12 shows a portion of the loading station of FIGS. 3-11. Specifically, FIG. 12 shows an embodiment of a single module suitable for being installed flanked by other analogous modules for defining the loading station shown in FIGS. 3-11. For simplicity of representation, some components of the module have been hidden. In particular, the shown module comprises a single conveyor device;

FIG. 13 shows, in a front view, a conveyor device suitable for being installed in the loading station of FIGS. 3-11 and in the module of FIG. 12;

FIG. 14 shows, in a perspective view, the conveyor device of FIG. 13;

FIG. 15 shows a component of the conveyor device of FIGS. 13 and 14 with some hidden components;

FIG. 16 shows a section view of a further component of the conveyor device of FIGS. 13 and 14;

FIG. 17 shows a plan view from above of the loading station, in the execution of a step of extraction of a plurality of objects from a conveyor apparatus;

FIG. 18 shows in a schematic form the steps of an unloading process of at least one object from a conveyor apparatus according to the present disclosure.

### DETAILED DESCRIPTION

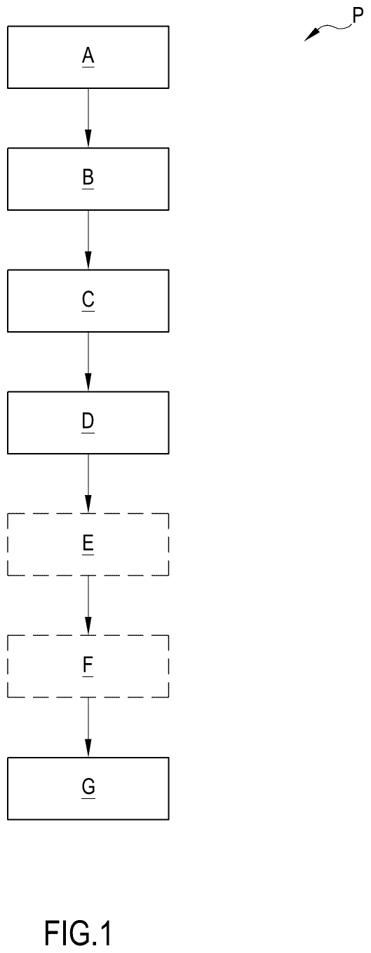

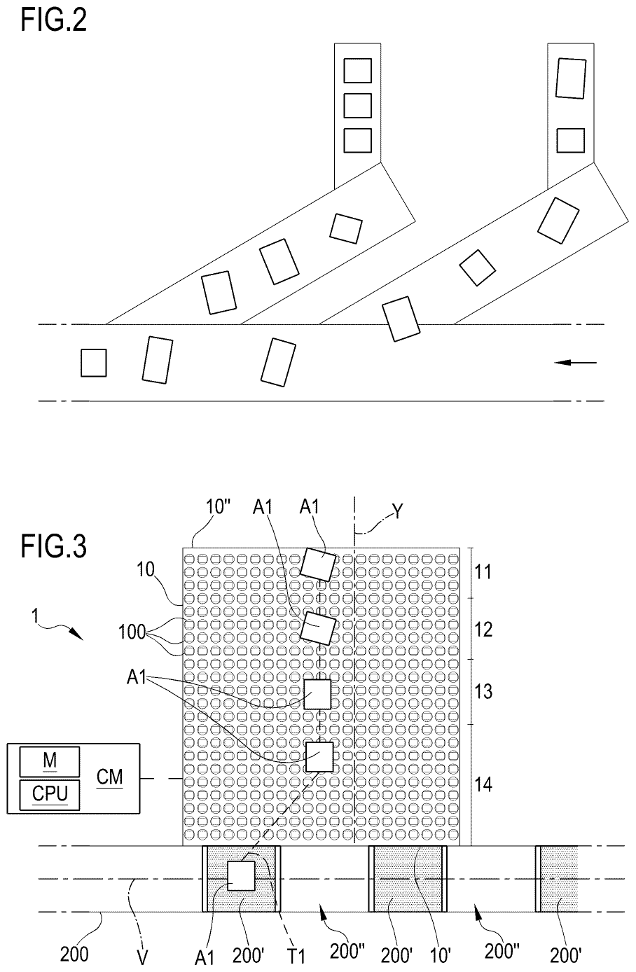

In FIG. 1, with reference P has been overall indicated a process for a loading of objects A1-A9 on a conveyor apparatus 200. Specifically, the conveyor apparatus 200 is configured to receive one or more objects A1-A9 and to convey these objects along a forward direction V, typically towards operative areas where the objects A1-A9 can undergo a further processing and/or a new addressing. Preferably, as shown in the attached figures, the conveyor apparatus 200 comprises a conveyor belt.

The conveyor apparatus comprises, in particular on the conveyor belt, a plurality of predefined loading area 200′, interspersed by division areas 200″. The division areas 200″ are areas wherein must not be loaded objects A1-A9. In each loading area 200′ can be loaded at least one object A1-A9. The loading areas 200′can be of equal size, or be of size different to each other. The division areas 200″ can have a size similar to the size of the loading area 200′or have a size different with respect to the latter.

The loading areas 200′can be physically different with respect to the division areas 200″, or alternatively they can be virtual areas, arbitrarily defined on the surface of the conveyor belt. The same applies to the division areas 200″. The loading area 200′can be then considered a loading module.

The division areas 200″ determine a physical separation, in particular on a significantly horizontal plane, or in any case a discontinuity, between the supporting surfaces of two loading areas 200′close to each other (separated, in fact, by the division area 200″).

The process P comprises a step A) of arranging a loading station 1 defining a handling surface 10 operatively associated to said conveyor apparatus 200. Preferably, the handling surface 10 is planar, and realizes therefore a handling plane, and in particular a sliding plane, for the objects A1-A9.

The conveyor apparatus, and in particular the conveyor belt, is arranged in substantial proximity of, almost in contact with, a peripheral portion of the handling surface 10.

The conveyor belt moves with respect to the handling surface 10; consequently, the loading areas 200′in use move with respect to the handling surface 10. The speed assumed by the conveyor belt can be a substantially constant speed or a time-varying speed.

As it will result more clearly hereinafter, the loading station 1 is configured to receive the objects A1-A9 on the relative handling surface 10 and to move these objects A1-A9 for loading them, in an opportune way, on the conveyor apparatus 200. Specifically, FIGS. 3-11 show some embodiments of the loading station 1 during the execution of the steps of the process P. In the following description further details of the loading station 1 will be indicated.

Preferably, step A) provides that the handling surface 10 of the loading station 1 extends away from the conveyor apparatus 200 starting from a proximal end 10′, substantially contiguous with the conveyor apparatus 200 up to a distal end 10″.

Still preferably, the handling surface 10 extends away from the conveyor apparatus 200 along a loading direction Y. Specifically, the loading direction Y is inclined with respect to the forward direction V of the conveyor apparatus 200. Optionally, as shown in FIGS. 3-9 and 11, the loading direction Y is perpendicular with respect to the forward direction V. Alternatively, as shown in FIGS. 9 and 10, the loading direction Y is inclined with an angle different from 90°, for example 30° or 45°,with respect to the forward direction V.

In a preferred embodiment, step A) provides that the handling surface 10 of the loading station 1 is defined at least partially by a plurality of conveyor devices 100 arranged according to a planar matrix. Preferably, the plurality of conveyor devices 100 is homogeneously distributed on the extension of the handling surface 10. In accordance with this embodiment, each conveyor device 100 is configured to be activated in order to locally control a translation of an object A1-A9 present on the handling surface 10. Preferably, each conveyor device 100 is configured to be activated in order to locally control a rotation of said object A1-A9 around a respective rotation axis, optionally orthogonal to the handling surface 10. Still preferably, the plurality of conveyor devices 100 is configured to singularize two or more objects A1-A9 at least partially overlapping and respectively arranged at heights different from each other with respect to the handling surface 10. Further construction and functional details of conveyor devices 100 will be introduced in the following.

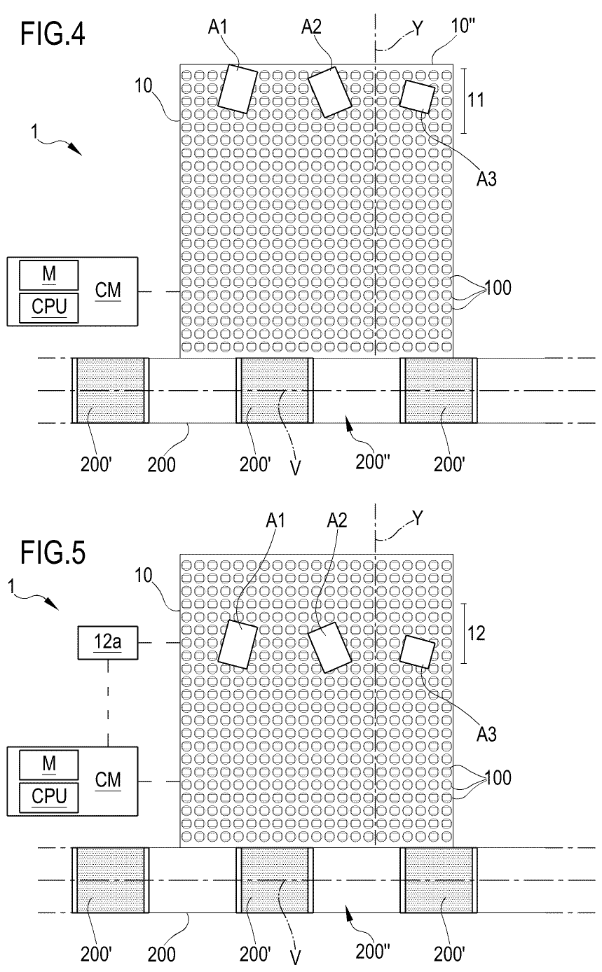

Subsequently, the process P comprises a step B) of loading at least one object A1-A9 on the handling surface 10, exemplarily shown in FIG. 4. In particular, step B) provides that at least one object A1-A9 is deposited on the handling surface 10. The objects A1-A9 deposited on the handling surface 10 can be objects of any typology or shape, and for this reason the box shape schematically indicated in the attached figures should be intended in an exemplary and non-limiting manner.

Preferably, as shown in FIG. 4, step B) provides that the object or objects A1-A9 are loaded in substantial correspondence of the distal end 10″ of the handling surface 10. By way of example, the objects A1-A9 can be deposited on the handling surface 10 manually or can arrive from other conveyor apparatus, such as belts and/or slides, as shown for example in FIGS. 9 and 10.

Optionally, in step B), objects A1-A9 can be simultaneously loaded on the handling surface 10. By way of example, as shown in FIG. 4, three objects A1-A3 can be loaded in a substantially simultaneous way on the handling surface 10.

Furthermore, the process P comprises a step C) of detecting the at least one object A1-A9 on said handling surface 10 shown in FIG. 5. In particular, step C) provides for detecting the presence on the handling surface 10 of the object or of the objects deposited during the execution of step A).

Preferably, step C) provides for localizing each object A1-A9 present on the handling surface 10. In detail, step C) provides for calculating the position of each object A1-A9 in the handling surface 10.

In an embodiment, step C) provides for detecting each object A1-A9 on the handling surface 10 by means of a vision system. Optionally, the vision system comprises one or more cameras, according to the extension of the surface to be controlled.

Preferably, step C) provides for recognizing, at least partially, a shape of each object A1-A9. Optionally, step C) provides for recognizing the projection of each object A1-A9 on the handling surface 10. In other words, in step C), is assessed the portion of handling surface 10 that is occupied by each detected object.

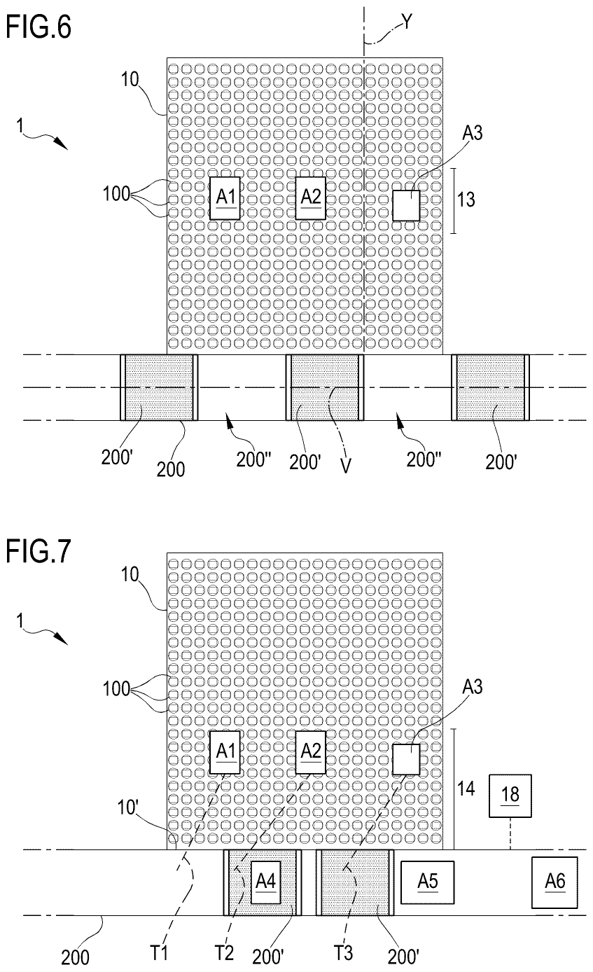

In accordance with what is shown in FIG. 1, the process P can comprise a step D) of orienting the at least one object A1-A9 according to a predefined orientation. The orientation, if already considered correct in relation to a subsequent trajectory to be made by the at least one object A1-A9, can be maintained unaltered with respect to a pre-set orientation, in particular imposed by the above-mentioned step B). The result of the execution of step D) appears clearly from the comparison between FIGS. 5 and 6.

In an embodiment, step D) provides for a rotation of each object A1-A9 for reaching the predefined orientation. In particular, said rotation takes place around a respective rotation axis of each of the objects A1-A9. The rotation axis is substantially inclined with respect to the handling surface 10, and is preferably orthogonal with respect to the plane locally detected by the handling surface 10.

Preferably, the predefined orientation of each object A1-A9 is determined in accordance with the corresponding projection on the handling surface 10 assessed during the execution of step C). In the embodiment of the attached figures, the predefined orientation corresponds to an orientation of the object wherein the relative size of main development is parallel to the loading direction Y.

Optionally, the process P comprises a step E) of assessing at least one status parameter of each object A1-A9.

According to the embodiment, step E) provides for the execution of at least one of the following activities:
a measurement of a weight of each object A1-A9; and/or
a measurement of a volume of each object A1-A9; and/or
a scanning of an identification code, optionally a bar code, of each object A1-A9.

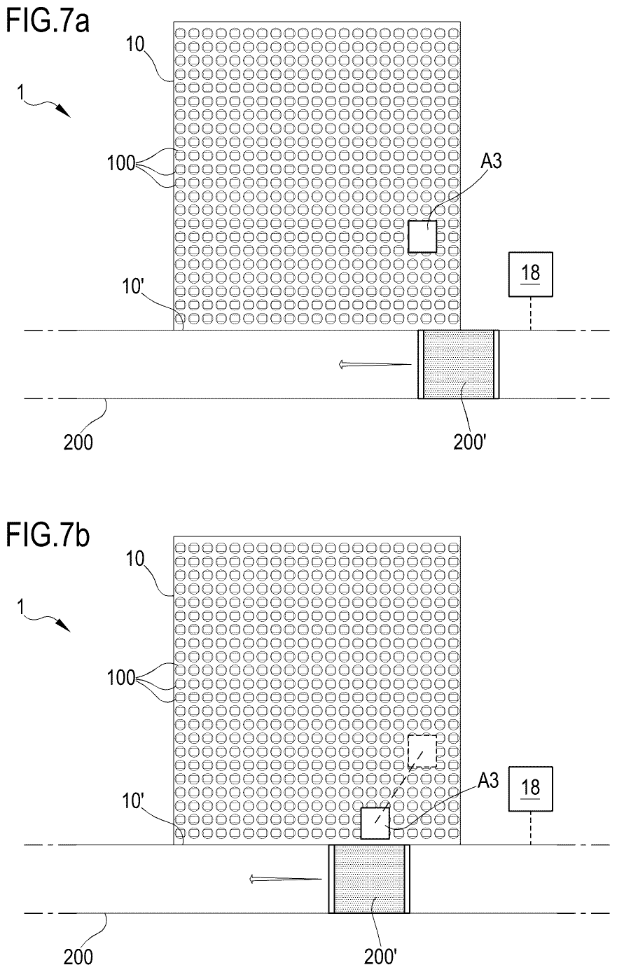

Subsequently, as shown in FIG. 7, the process P comprises a step F) of defining an insertion trajectory T1-T3 on said conveyor apparatus 200 for each object A1-A9. In particular, the insertion trajectory T1-T3 is individually defined for each object A1-A9 in accordance with a condition of said conveyor apparatus 200 and/or with a number of objects A1-A9 present on the handling surface 10. In more detail, the insertion trajectory of each object is calculated according to the arrangement of objects already present on the conveyor apparatus and/or in accordance with the number of objects still present on the handling surface and waiting to reach the conveyor apparatus itself. Advantageously, as will become clearer in the following, the presence of step F) allows to have available a process P of adaptive type, wherein the parameters that define the insertion trajectory T1-T3 of each object vary dynamically, in particular in accordance with the status of the loading station 1 and/or of the conveyor apparatus 200.

Preferably, in accordance with what is shown in FIG. 7, step F) provides for, for each object A1-A9, the definition of an insertion path ending on the insertion trajectory 200. Specifically, each insertion path has a respective inclination, measured in terms of angle comprised between the insertion trajectory T1-T3 and the forward direction V of the conveyor apparatus 200. Therefore, step F) provides for the definition of a trajectory customized for each object A1-A9. In other words, for each object present on the handling surface, a loading line is virtualised on the conveyor apparatus 200 having a respective insertion path with an inclination calculated in accordance with the arrangement of the objects already present on the conveyor apparatus 200 and/or in accordance with the number of objects still present on the handling surface and waiting to reach the conveyor apparatus itself.

The above-mentioned inclination can have a variable angle, and preferably the angle can be varied and/or adapted in accordance with the position that the at least one object A1-A9 will assume on the conveyor apparatus 200, in particular on the predefined loading area 200′or in accordance with which-among a plurality of loading areas 200′-will be the specific loading area on which must be addressed the at least one object A1-A9.

Optionally, step F) provides that the insertion trajectory T1-T3 of each object comprises at least a straight section. By way of example, as shown in FIG. 7, each insertion trajectory coincides with a straight section. In further embodiments, not shown, step F) provides that the insertion trajectory T1-T3 of each object can comprise at least a curvilinear section.

Still preferably, step F) provides for, for each object A1-A9, the definition of an insertion speed for the corresponding insertion trajectory T1-T3

In an embodiment, the insertion speed for the corresponding trajectory is defined for all the objects A1-A9. Optionally, instead, the insertion speed is defined, for each object A1-A9, in accordance with the inclination of the respective insertion path on the conveyor belt. Preferably, the insertion speed is directly proportional to the inclination of the insertion trajectory T1-T3. By way of example, greater angles between the insertion trajectory and the forward direction V of the conveyor apparatus 200 correspond greater insertion speeds and vice versa. Advantageously, the possibility of choosing an insertion speed customized in accordance with the inclination of the insertion trajectory allows to eliminate misalignment problems in the passage of each object from the handling surface 10 to the conveyor apparatus 200.

In some preferred embodiments, the process P provides, in step F), for adjusting the insertion speed on the conveyor apparatus 200, and in particular on the conveyor belt, in accordance with the handling speed of the predefined loading area 200′. This adjustment can take place in simultaneity with the adjustment as a function of the insertion trajectory.

In particular, the greater the handling speed of the predefined loading area 200′ with respect to the handling surface 10, the greater the insertion speed on the conveyor apparatus 200.

In accordance with what is shown in FIG. 7, when a plurality of objects A1-A3 shall be loaded onto the conveyor apparatus in a substantially simultaneous manner, step F) provides for the definition of a plurality of insertion trajectories T1-T3, one for each object of the plurality of objects A1-A9. It should be noted how the trajectories that compose this plurality of insertion trajectories T1-T3 differ from each other.

Preferably, the trajectories that compose this plurality of insertion trajectories T1-T3 have insertion paths different from each other and/or inclinations different from each other and/or insertion speeds different from each other. With reference to FIG. 7, for example, it is possible to note that the trajectory defined for object A1 is different from the trajectory defined for object A2. In particular, the insertion trajectory T1 defined for object A1 has a greater inclination with respect to the insertion trajectory T2 defined for object A2. By virtue of the aforementioned, therefore, for the insertion trajectory T1 is preferably set a higher input speed with respect to the input speed defined for the insertion trajectory T2.

In some embodiments, the speed and/or the inclination are time-varying, i.e. in the course of handling the respective object on the handling surface 10, they vary.

Each one between the object A1 and the object A2, may therefore be moved in such a way as to have a first speed and/or inclination in correspondence of a first portion of the handling surface and a second speed and/or inclination in correspondence of a second portion of the handling surface.

In view of the above, it is therefore clear that the present disclosure shows a process wherein step F) provides, for at least one object A1-A9, and in particular for a plurality of objects where present, for the definition of a first input speed and a second input speed, respectively associated to a first and a second portion of the handling surface 10.

Analogously, the present disclosure shows a process that can comprise defining for at least one object, and in particular for each object A1-A9, a first inclination and a second inclination, respectively associated to a first and a second portion of the handling surface 10.

This, moreover, allows to handle objects with insertion trajectories (paths) that, as a whole, can cross each other even more than once, allowing a remarkable fluidity in handling and conveying objects.

The process herein described obviously provide for, where there is a crossing of trajectories, an absence of collision of objects.

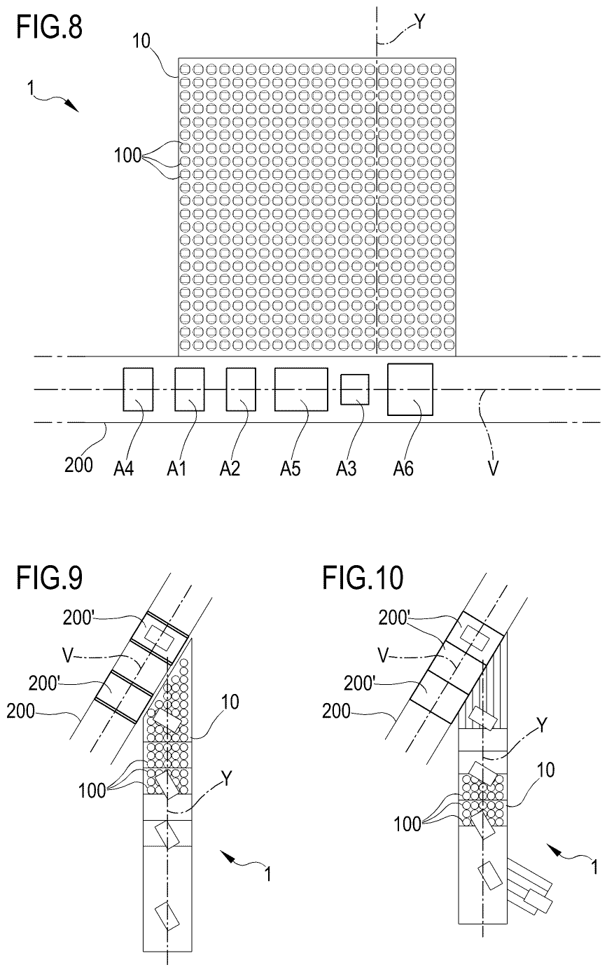

Finally, as shown in FIG. 8, the process P comprises a step G) of inserting each object A1-A9 on the conveyor apparatus 200 in accordance with the corresponding insertion trajectory T1-T3. Advantageously, the execution of the process P allows an optimal occupation of spaces on the conveyor apparatus 200 and an optimisation of the productivity of the conveyor system.

In particular, step G) takes place by inserting at least one object (A1-A9) on a predefined loading area 200′of said conveyor apparatus. Preferably, such step G) takes place by inserting the at least one object A1-A9 onto a loading area 200′while said loading area is moved with respect to the handling surface 10.

Step G) is preferably, therefore, a step in which there is a synchrony, i.e. a coordinated movement, between the at least one object A1-A9 and the conveyor belt; the at least one object A1-A9 is therefore moved in substantial temporal simultaneity such that it is loaded not randomly onto the conveyor apparatus 200, but onto a predefined loading area 200′of the conveyor apparatus.

More specifically, when the at least one object A1-A9 arrives in correspondence of the peripheral portion of the handling surface 10, said at least one object A1-A9 is in substantial correspondence of, for example substantially aligned and contiguous to, the predetermined loading area 200′.

More precisely, technically, the process P receiving electronic handling data of the conveyor belt from the conveyor apparatus 200. Such electronic data are configured to allow to detect, substantially in real time, the position of the predefined loading area 200′with respect to the handling surface 10, in particular with respect to the peripheral portion of the handling surface 10, so that it is then possible to proceed with a handling of the at least one object A1-A9 in accordance with the insertion trajectory T1-T3 and in accordance with the electronic handling data. Step G) determines preventing the loading of objects on the division area 200″.

In a preferred embodiment, the process P comprises in particular defining and/or adapting the insertion trajectory T1-T3 of the at least one object A1-A9 (if several objects are present, the insertion trajectory of each object in the plurality of objects) in accordance with the electronic handling data.

FIG. 7a shows a situation wherein the predefined loading area 200′is in a remote position with respect to the handling surface 10, but through the handling data transmitted towards the loading station 1, in particular towards a controlling module CM of the latter, it is possible to define a trajectory for the object A3. The conveyor belt, and thus the predefined loading area 200′forwards to the left. FIG. 7b shows a situation in a time instant subsequent with respect to the one of FIG. 7a. The object A3 is in substantial correspondence of the peripheral portion of the handling surface 10 (side) in correspondence thereof it is present the conveyor belt. It is noted that the predetermined loading area 200′is forwarded to the left and is in close proximity to the peripheral portion and the object A3. The object A3, in time instants slightly subsequent with respect to the one of FIG. 7b, will be loaded on the predefined loading area 200′.

With reference to FIGS. 3-13, are herein described some embodiments of a loading station 1 of objects A1-A9 on the conveyor apparatus 200 particularly suitable for the execution of the previously described process P.

In accordance with what is shown in FIG. 3, the loading station 1 defines the handling surface 10 operatively associated to the conveyor apparatus 200, in particular flanked by the conveyor apparatus 200. Specifically, the handling surface 10 comprises:
a loading portion 11 configured to receive at least one object A1-A9 on said handling surface 10;
a controlling portion 12 configured to identify the object or objects A1-A9 on the handling surface 10;
an inserting portion 14 configured to insert the object or objects A1-A9 on the conveyor apparatus 200 according to a corresponding insertion trajectory T1-T3.

In a preferred embodiment, the loading station 1 comprises an orienting portion 13 configured to orient the object or objects A1-A9 according to a predefined orientation, or to maintain the object or objects A1-A9 in a pre-set direction.

In relation to FIG. 3, it is noted that in accordance with the specific need, the size of the orienting portion 13, also in relation to the other above-defined portions, can vary.

In addition, the loading station 1 comprises at least a controlling module CM. This controlling module CM is operatively associated at least to the controlling portion 12, to the orienting portion 13 and to the inserting portion 14. Specifically, the controlling module CM is configured to define an insertion trajectory T1-T3, individually for each object A1-A9 in accordance with the condition of the conveyor apparatus 200 and/or with the number of objects A1-A9 present on the handling surface 10. In other words, on the basis of the occupancy status of the conveyor apparatus 200 and/or the number of objects A1-A9 present on the handling surface 10, the controlling module CM calculates, in a customised way for each object A1-A9, an insertion trajectory T1-T3 for the loading of said object onto the conveyor apparatus.

Preferably, as shown in the attached figures, the controlling module CM comprises a memory device M configured to house a computer program suitable for allowing an automated execution of the process P previously described. Still preferably, the controlling module CM further comprises a processing unit CPU configured to compile and execute the computer program hosted on the memory device M in order to execute the steps of the procedure P via the loading station 1. Alternatively or in combination, the processing unit CPU can comprise a general purpose processor, a dedicated processor, for example an ASIC, and/or an FPGA and/or a programmable logic controller (PLC).

In a preferred embodiment, the controlling module CM is configured to cause an insertion of the at least one object A1-A9 on the loading area 200′, which is movable with respect to the handling surface 10 and in particular is configured to cause an insertion of the at least one object A1-A9 on said predefined loading area 200′, in accordance with the insertion trajectory T1-T3 previously electronically calculated.

In particular, the controlling module CM, being able to electronically identify in substantially real time the future position of the at least one object A1-A9 on the loading area 200′, also electronically detects the position assumed by the at least one division area 200″ and is therefore programmed to make sure that no object is loaded on the division area 200″.

The conveyor apparatus 200 is operatively connected with the loading station 1, and in particular with the controlling module CM of this latter, to transmit at least handling electronic data; the handling electronic data are electronic data that indicate, preferably in real time, the position assumed by the predefined loading area 200′with respect to the handling surface 10, and more in particular with respect to the peripheral portion of the handling surface.

In use, the controlling module CM receives handling electronic data of the predefined loading area 200′from the conveyor apparatus, and causes an insertion of the at least one object A1-A9 on the predefined loading area 200′in accordance with the insertion trajectory T1-T3 of said object and in accordance with the handling electronic data.

More in particular, the controlling module CM uses the handling electronic data to define and/or adapt, preferably in real time, the insertion trajectory T1-T3 in accordance with the handling electronic data.

The processing unit can be configured to allow a variation of the size of one or more of the loading portion 11, the controlling portion 12, the orienting portion 13 and the inserting portion 14.

Optionally, the controlling module CM is connected operatively to a user interface to allow the interaction with a user, for example an operator at the loading station 1. According tot he embodiments, the user interface is of local and/or remote type.

Preferably, the computer program comprises a plurality of instructions suitable for being executed in sequence for the execution of said process P of loading. For instance, the computer program comprises a plurality of code portions, each one comprising a plurality of instructions suitable for being compiled for the execution of one of the steps of the process P by means of the loading station 1.

Still preferably, the computer program comprises at least one self-learning algorithm, also called machine learning algorithm. In an embodiment, the computer program comprises at least a supervised machine learning algorithm. In another embodiment, alternative or combinable with the preceding one, the computer program comprises at least a supervised machine learning algorithm. Advantageously, the implementation of one or more machine learning algorithms allows to make available a decision maker of the insertion trajectory T1-T3 of each object optimised on the basis of the actual utilisation data of loading station 1 and the corresponding conveyor apparatus 200.

According to what is shown in the attached figures, the handling surface 10 extends away from the conveyor apparatus 200 from a proximal end 10′to a distal end 10″. In greater detail, the proximal end 10′comprises the set of points at a minimum distance from the conveyor apparatus 200 and is substantially contiguous with the conveyor apparatus 200, while the distal end 10″ comprises the set of points at a maximum distance from the conveyor apparatus 200.

Preferably, as shown in FIGS. 3 and 4, the loading portion 11 comprises the distal end 10″ and the inserting portion 14 comprises the proximal end 10′. In the embodiment of FIGS. 3-8, starting from the distal end 10″ to the proximal end 10′, the handling surface 10 comprises, in order, the loading portion 11, the controlling portion 12, the orienting portion 13 and the inserting portion 14. In particular, the inserting portion 14 results contiguous with the conveyor apparatus 200 so as to allow the passage of objects A1-A9 from the loading station 1 to the conveyor apparatus itself.

As previously mentioned, the handling surface 10 extends away from said conveyor apparatus 200 along a loading direction Y. Specifically, the proximal end 10′ and the distal end 10″ result aligned along said loading direction Y. Said loading direction Y results inclined with respect to the forward direction V of the conveyor apparatus 200. In a preferred embodiment, as shown in the annexed FIGS. 3-8 and 11, said loading direction Y is perpendicular with respect to the forward direction V. In alternative embodiments, exemplarily shown in FIGS. 9 and 10, the loading direction Y is inclined with respect to the forward direction V by an angle different from 90°, for example between 20° or 60°, more preferably between 30° and 45°.

The handling surface 10 has plane polygonal shape. Preferably, the handling surface 10 has the shape of a quadrilateral, more preferably of parallelogram as shown in FIGS. 3-11. In a preferred embodiment, shown in FIGS. 3-8 and 11, the handling surface 10 has rectangular shape. In alternative embodiments, shown in FIGS. 9 and 10, the handling surface has rhomboid shape. Preferably, a pair of sides defining the perimeter of the handling surface 10 is parallel to the loading direction Y, while the remaining pair of sides is parallel to the forward direction V of the conveyor apparatus 200.

According to what is shown in FIG. 4, the loading portion 11 comprises the distal end 10″ and represents the portion of the handling surface 10 furthest from the conveyor apparatus 200. The aforementioned loading portion 11 is configured to receive the objects A1-A9 which shall reach the conveyor apparatus 200 by means of roto-translational movements on the handling surface 10. According to the embodiments, the loading portion 11 provides that the objects A1-A9 are loaded manually and/or by means of other conveying apparatus, such as belts and/or slides as shown for example in FIGS. 9 and 10.

Optionally, the loading portion 11 is configured to receive simultaneously a plurality of objects A1-A9. By way of example, in FIG. 4 is shown a circumstance in which the loading portion 11 receives in a substantially simultaneous way three objects A1-A3.

As shown in FIG. 5, the loading station 1 comprises at least one controlling sensor 12a operatively connected to the loading portion 12. In the embodiment shown in FIG. 5, only one controlling sensor 12a is depicted; however, this embodiment is to be intended as an example and absolutely non-limiting since the loading station 1 can comprise several controlling sensors 12a, depending on the extent of the controlling portion 12 to be supervised.

In detail, the controlling sensor 12a is configured to detect the objects A1-A3 in the controlling portion 12 of the handling surface 10. Optionally, the controlling sensor 12a is configured to localize the objects A1-A3 in the controlling portion 12 of the handling surface 10. In other words, the controlling sensor 12a is configured to return the position of the objects A1-A3, in the controlling portion 12.

Furthermore, the controlling sensor 12a is operatively connected to the controlling module CM and is configured to send a signal representative of the recognition of one or more objects within the controlling portion 12.

In an embodiment, the controlling sensor 12a comprises one or more cameras suitable for supervising the controlling portion 12 to detect the presence of one or more objects A1-A9. In alternative embodiments, the controlling sensor 12a comprises other typologies of devices suitable for recognising the objects A1-A9, such as for example solutions based on time-of-flight (ToF) techniques.

Optionally, the controlling sensor 12a is configured to identify simultaneously several objects present in the controlling portion 12. With reference to the exemplary embodiment of FIG. 5, the controlling sensor 12a identifies in a substantially simultaneous way the three objects A1-A3 in the controlling portion 12.

Preferably, the controlling sensor 12a is configured to recognize, at least partially, the shape of each object A1-A9. Even more preferably, the controlling sensor 12a is configured to recognize the projection of each object A1-A9 in the controlling portion 12. In other words, by means of an eventual processing executed by the controlling module CM, the controlling sensor 12a allows to assess the portion of handling surface 10 that is occupied by each detected object.

According to what is shown in FIG. 6, the orienting portion 13 is configured to arrange the objects A1-A9 according to a predefined orientation. Preferably, the orienting portion 13 is configured to rotate the objects A1-A9 around a respective rotation axis until the reaching of the predefined orientation, as clear from the comparison between FIGS. 5 and 6. Optionally, the rotation axis is perpendicular to the handling surface 10.

Preferably, the predefined orientation of each object A1-A9 is determined in accordance with the corresponding projection on the handling surface 10 assessed by means of the controlling sensor 12a. In the embodiment of the attached figures, the predefined orientation corresponds to an orientation of the object wherein the relative size of main development is parallel to the loading direction Y.

Optionally, the orienting portion 13 is configured to receive simultaneously a plurality of objects A1-A9 according to the respective predefined orientations. From the comparison between FIGS. 5 and 6 is clear how the three objects A1-A3 present in the orienting portion 13 are addressed, in particular rotated, in a substantially simultaneous way.

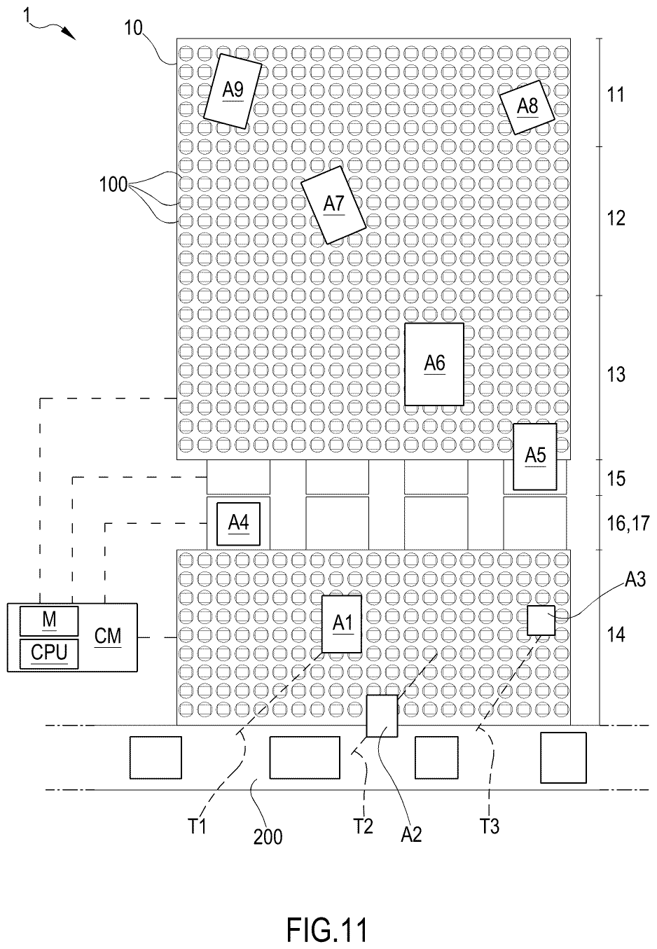

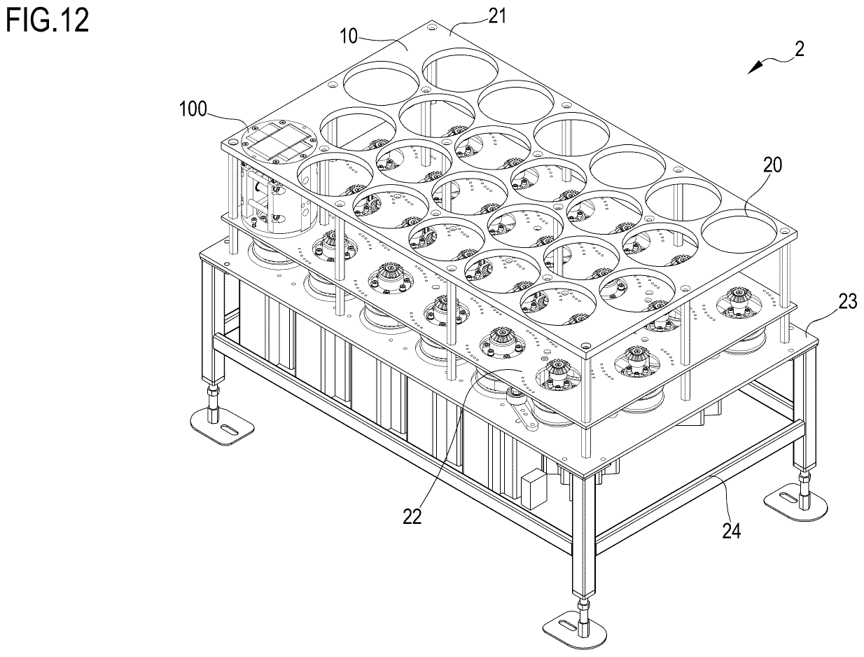

Optionally, as shown in the embodiment of FIG. 11, the handling surface 10 comprises a weighing portion 15. Specifically, the weighing portion 15 is configured to measure a weight of one or more objects A1-A9. Preferably, the weighing portion 15 comprises at least one weight sensor operatively connected to the controlling module CM to send a signal representative of the weight of each object in the weighing portion 15. In an exemplary embodiment, each weight sensor comprises at least one loading cell.

Still optionally, in accordance with what is shown in FIG. 11, the handling surface 10 comprises a volume assessment portion 16. In detail, the volume assessment portion 16 is configured to measure the objects A1-A9 that transit thereon. Preferably, the volume assessment portion 16 comprises at least one sensor, in particular an optical sensor, operatively connected to said controlling module CM to send a signal representative of the volume of each object present in the volume assessment portion 16. In an exemplary embodiment, the volume assessment portion 16 comprises at least one camera.

Still optionally, as show in FIG. 11, the handling surface 10 comprises a reading portion 17 configured to execute a scanning of at least one identification code of the objects A1-A9 that transit thereon. Specifically, objects A1-A9 have typically an identification code suitable for allowing the univocal recognition. By way of example, the identification code can be a bar code or a QR code. Preferably, the reading portion 17 comprises one optical sensor operatively connected to said controlling module CM to send a signal representative of the reading carried out for each object present in the reading portion 17.

As shown in FIG. 7, the inserting portion 14 comprises the proximal end 10′and represents the portion of the handling surface 10 nearest from the conveyor apparatus 200. In particular, the inserting portion 14 results contiguous with the conveyor apparatus 200 so as to allow the passage of objects A1-A9 from the loading station 1 to the conveyor apparatus itself. Specifically, the inserting portion 14 is configured to address each object A1-A3 towards the conveyor apparatus 200, in accordance with the respective insertion trajectory T1-T3 calculated, in a customized way for each single object, by the controlling module CM.

For the purpose of allowing the loading of each object on the conveyor apparatus 200, the controlling module CM determines an insertion trajectory T1-T3 in a customised way for each object A1-A9. In particular, the insertion trajectory T1-T3 is individually defined for each object A1-A9 by the controlling module CM in accordance with a condition of the conveyor apparatus 200 and/or with the number of objects A1-A9 present on the handling surface 10. In more detail, the insertion trajectory of each object is calculated in accordance with a condition of the conveyor apparatus 200 that comprises the arrangement of objects already present on the conveyor apparatus and/or in accordance with the number of objects still present on the handling surface and waiting to reach the conveyor apparatus itself. As shown in the synoptic view of FIGS. 7 and 8, the inserting portion 14 then addresses each object A1-A3 in accordance with the respective insertion trajectory T1-T3 determined by the controlling module CM. Substantially, for each object present on the handling surface, the controlling module CM generates a respective virtualised loading line ending on the conveyor apparatus 200. This loading line can be duplicated on the overall handling surface 10, or can be adapted in size, handling speed and inclination with respect to the conveyor apparatus 200 and/or with respect to other virtualised loading lines.

This technical characteristic allows to increase the operational flexibility of object handling, since the number of virtualised loading lines, the size of each of them, and/or the inclination defined by the insertion trajectory can be freely altered.

In particular, the limitations of objects traditionally handled by non-virtualised loading lines are eliminated, due to the fact that the virtualised loading lines can be made variable in size through the greater or lower involvement of conveyor devices 100.

Optionally, the inserting portion 14 is configured to simultaneously insert a plurality of objects A1-A9 on said conveyor apparatus 200 according to a plurality of insertion trajectories T1-T3, wherein each insertion trajectory is calculated by the controlling module CM in a customized way for each object in accordance with the condition of the conveyor apparatus 200 and/or with the number of objects A1-A9 present on the handling surface 10. By way of example, the comparison between FIGS. 7 and 8 highlights how the three objects A1-A3 are inserted on the conveyor apparatus 200 in a substantially simultaneous way, each one following a respective customized insertion trajectory T1-T3 in order to allow an optimisation of the productivity of the conveyor system.

Preferably, the loading station 1 comprises a surveillance module 18 operatively connected to the conveyor apparatus 200 and to the controlling module CM. This surveillance module 18 is configured to monitor the condition of the conveyor apparatus 200 upwards of the loading station 1. In other words, the surveillance module 18 is configured to monitor the loading situation of the conveyor apparatus 200 upwards of the loading station. In greater detail, the surveillance module 18 is configured to analyse the arrangement of the objects eventually already present on the conveyor apparatus 200 so as to detect free spaces wherein inserting the objects A1-A9 present on the handling surface 10 and allow the calculation of the insertion trajectories T1-T3 in order to maximise the productivity of the conveyor apparatus itself.

Each insertion trajectory T1-T3 generated by the controlling module CM is characterized by a relative insertion path ending on the conveyor apparatus 200. Specifically, each insertion path has a respective inclination, measured in terms of angle comprised between the insertion trajectory T1-T3 and the forward direction V of the conveyor apparatus 200.

The above-mentioned inclination can have a variable angle; in an embodiment, therefore, the controlling module CM is configured to vary and/or adapt the angle in accordance with the position that the at least one object A1-A9 will assume on the conveyor apparatus 200, in particular on the predefined loading area 200′or in accordance with which—among a plurality of loading areas 200′—will be the specific loading area on which must be addressed the at least one object A1-A9.

In addition, each insertion trajectory T1-T3 generated by the controlling module CM is characterised by a corresponding insertion speed with which the corresponding object A1-A9 travels along the insertion path. Preferably, the insertion speed is defined, for each object A1-A9, in accordance with the inclination of the respective insertion path. More preferably, the insertion speed is directly proportional to the inclination of the insertion trajectory T1-T3. By way of example, greater angles between the insertion trajectory and the forward direction V of the conveyor apparatus 200 correspond greater insertion speeds and vice versa.

More in detail, the controlling module CM can adjust the insertion speed in such a way that it is the same for all the objects A1-A9, in particular in accordance with the insertion angle on the conveyor apparatus 200, or to allow-even at the same insertion angle-an independent insertion speed for each object A1-A9 of the plurality of objects. In a specific embodiment, the controlling module CM adjusts the insertion speed in such a way as to make it time-varying, and/or adjusts the inclination in such a way as to make it time-varying.

The controlling module CM can be configured to adjust speed and/or inclination so that the at least one object A1-A9 present on the handling surface 10, and optionally each object A1-A9 present on the handling surface 10, can be handled at least at a first speed, which in use is present in a first portion of the handling surface 10, and at a second speed, which in use is present in the second portion of the handling surface 10. Analogously, the controlling module CM can be configured to cause the handling of the at least one object, and optionally of each object A1-A9 present on the handling surface, with a first inclination, in use in correspondence of a first portion of the handling surface 10 and with a second inclination, in use in correspondence of the second portion of the handling surface.

As already previously mentioned in the course of the description of the process P, in one embodiment the controlling module CM can be configured to avoid the collision of objects where the trajectory (insertion path) of an object A1 and of a second object A2, simultaneously present on the handling surface 10, cross each other at least once.

In addition, the controlling module CM, once the handling electronic data from the conveyor apparatus 200 are received, can also optionally adjust and/or adapt the speed of at least one object A1-A9, optionally of each of the objects A1-A9 of the plurality of objects A1-A9 present on the handling surface 10 in accordance with the handling speed of the predefined loading area 200′.

Preferably, as shown in the embodiments of FIGS. 3-11, the handling surface 10 is defined at least partially by a plurality of conveyor devices 100 arranged according to a matrix configuration, preferably wherein the plurality of conveyor devices 100 overall defines a plurality of rows parallel to each other and columns parallel to each other.

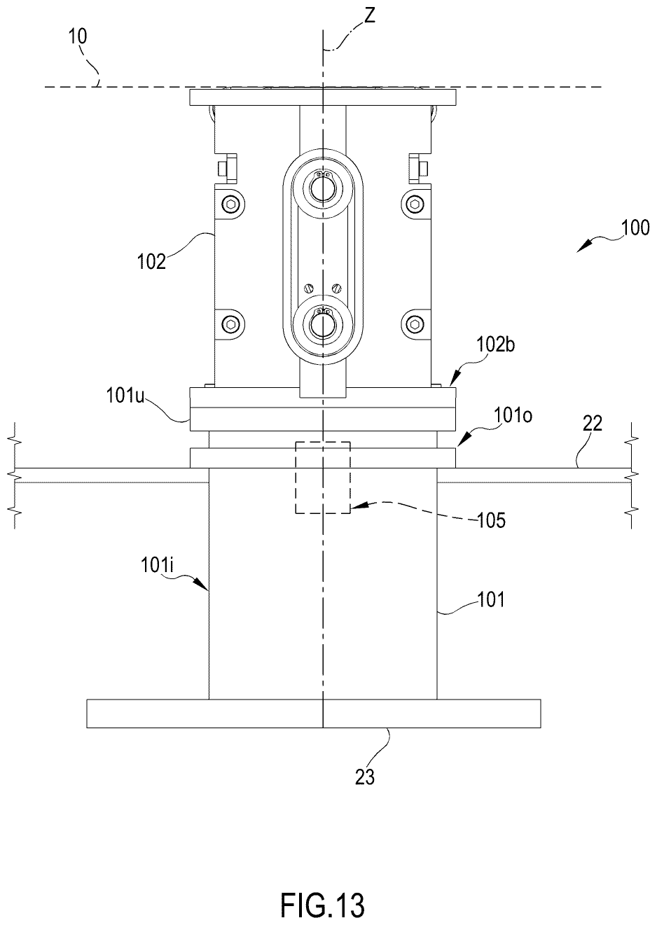

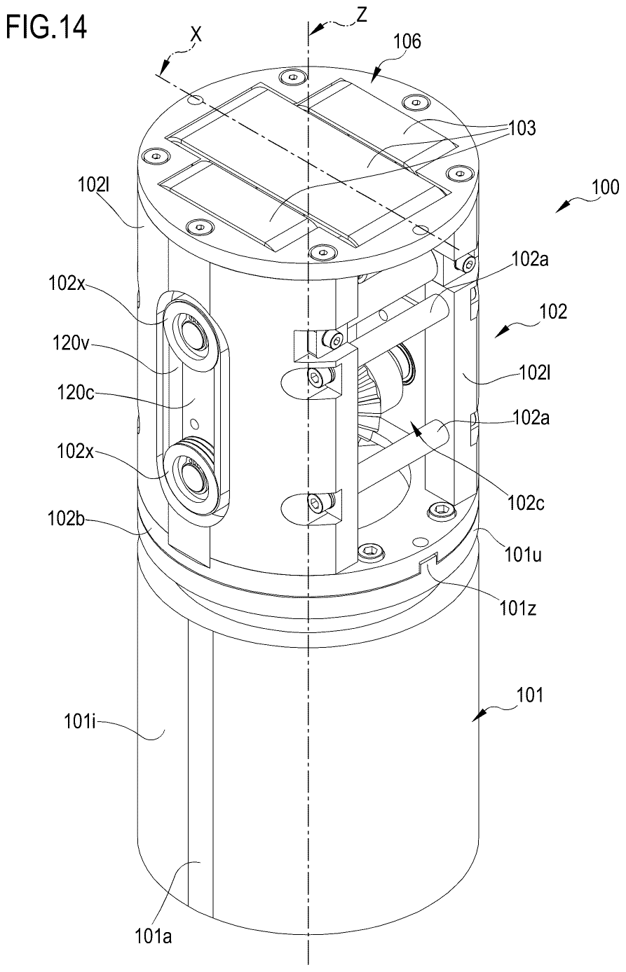

An embodiment of a conveyor device 100 usable in the context of the loading station 1 is shown by way of example in FIGS. 13 and 14.

Optionally, the plurality of conveyor devices 100 is homogeneously distributed on at least part of the extension of the handling surface 10. In an embodiment, exemplarily shown in FIGS. 3-8, the plurality of conveyor devices 100 covers, preferably in a homogeneous way, the entire extension of the handling surface. In other embodiments, such as for example the ones shown in FIGS. 9-11, the plurality of conveyor devices 100 covers only a portion of the handling surface 10 while the remaining parts of the loading station 1 are represented by different components, such as conveyor belts.

In its primary functions, each conveyor device of the plurality of conveyor devices 100 is configured to be activated in order to locally determine a roto-translation of an object A1-A9 on the handling surface 10.

In addition, each conveyor device of the plurality of conveyor devices 100 is configured to be activated in order to locally control a rotation of an object A1-A9 on the handling surface 10. In particular, the portion of the plurality of conveyor devices 100 that define the orienting portion 13 is configured to be activated in order to locally control a rotation of said at least one object A1-A9, present in said orientation portion. Optionally, the plurality of conveyor devices 100 is configured to singularize two or more objects A1-A9 at least partially overlapping and respectively arranged at heights different from each other with respect to the handling surface 10. Specifically, the plurality of conveyor devices 100 is configured to determine the fall on the handling surface of the object placed at a higher height, i.e. of the element not in contact with the handling surface itself.

Preferably, the handling surface 10 is at least partially defined by multiple modules 2 configured to be arranged flanked so as to define jointly a planar surface representing at least part of said handling surface 10. A module 2 is shown in an exemplary and partial manner in the attached FIG. 12. In accordance with what is shown, the module 2 comprises a plurality of seats 20 wherein each seat is configured to house a respective conveyor device 100.

Preferably, the module 2 comprises a first support plane 21 suitable for defining at least partially the handling surface 10. Optionally, the module 2 also comprises a second support plane 22, a third support plane 23 and a fourth support plane 24, preferably parallel to the first support plane 21 and arranged at a height lower with respect to the first support plane 21.

It is now described, with reference to FIGS. 13-16, an embodiment of a conveyor device 100 usable in the context of the loading station 1 and insertable in the module 2. The conveyor device 100 comprises preferably a supporting element 101 and a head element 102. Preferably, the head element 102 is removably installed on the supporting element 101 and is arranged at a height typically higher with respect to the height at which the supporting element 101 lies.

As shown in FIG. 12, in the context of module 2, the supporting element 101 is configured to be installed, in particular in a fixed and predetermined position, on the third support plane 23. Analogously, the head element 102 is configured to be installed on the second support plane 22 of the module 2. In greater detail, the supporting element 101 extends between the third support plane 23 and the second support plane 22, while the head element 102 extends between the second support plane 22 and the first support plane 21. Optionally, the conveyor device 100 comprises also a controlling element, operatively connected to the supporting element 101. The controlling element is preferably arranged at a lower height, in particular is installed on the fourth support plane 24 and extends between said fourth supporting plane and third support plane. In the shown embodiment, the head element 102 comprises at least a primary translator 103. The primary translator 103 is destined to translate the objects A1-A9 along at least a translation direction X.

The head element 102 detects a resting surface 106 for the object A1-A9 to be conveyed, that preferably is of planar type. In this sense, the resting surface 106 of the conveyor device 100 defines at least partially the handling surface 10 of the loading station 1 wherein it is installed. Therefore, the resting surface 106 results arranged at the same height of the first support plane 21 of the module 2 and the translation direction X lies on the handling surface 10.

The conveyor device 100 comprises also a rotation actuator 104 that is configured to rotate the head element 102 with respect to the supporting element 101 around the rotation axis Z. Specifically, the activation of the rotation actuator 104 allows to modify the orientation of the translation direction X in the handling surface 10. Specifically, the activation of the rotation actuator 104 allows to handle the objects A1-A9 on the handling surface 10 also along loading directions that differ from the loading direction Y. In particular, with reference to FIGS. 3, 7 and 11, the rotation of the head elements 102 allows to rotate the primary translator 103 so as to define insertion trajectories T1-T3 that result inclined at will both with respect to the loading direction Y and with respect to the forward direction V of the conveyor apparatus 200.

In addition, the activation of the rotation actuator 104 allows to rotate the objects A1-A9 with respect to a relative rotation axis, preferably perpendicular to the handling surface 10 and parallel to the rotation axis Z. In particular, the rotation of the head elements 102 allows to rotate the primary translator 103 so as to determine a rotation of an object that is in correspondence of the relative conveyor device 100 as clear from the comparison between FIGS. 5 and 6.

Optionally, the conveyor device 100 is configured to singularize two or more objects that are in correspondence of the head element 102 and that are partially overlapping and respectively arranged at heights different from each other with respect to the handling surface 10. Specifically, the conveyor device 100 is configured to define the fall of the object of the objects arranged at a higher height so that all the objects can be at the same height, i.e. the height of contact with the handling surface 10.

Optionally, in order to allow the singularization of two or more objects, the conveyor device 100 comprises a secondary translator 105 configured to cause a translation of at least a part of the head element 102 preferably at least of the primary translator 103 along a direction substantially parallel to the rotation axis Z with respect to the supporting element 101. In an embodiment, the secondary translator 105 is a vibrator, capable of handling the head element 102 by means of a substantially vibratory (reciprocating) movement along the rotation axis Z. The singularization can take place by means of a vibratory characteristic induced by the secondary translator 105. In a non-limiting embodiment, the secondary translator 105 can determine a reciprocating movement along the rotation axis Z of the primary translator 103 and/or of the resting surface 106 with a progressive acceleration and deceleration in two opposite directions along the rotation axis Z suitable for determining the fall on the handling surface 10 of the object placed at the higher height.

In a preferred embodiment, the at least one primary translator 103, the rotation actuator 104 and the secondary translator 105 are activatable in an independent way from each other. Specifically, the primary translator 103 can be activated in an independent way with respect to the rotation actuator 104 to allow the objects A1-A9 present on the handling surface 10 to be opportunely oriented in accordance with the predefined orientation and/or to follow the insertion trajectories T1-T3 calculated in a customized way for each object to be inserted on the conveyor apparatus 200. The activation of the conveyor device 100 comprises at least one between an activation of the primary translator 103, an activation of the rotation actuator 104 and an activation of the secondary translator 105.

In use, the activation of the primary translator 103 determines a putting in motion, in particular a rotation, of at least a roller or a belt that allows to translate and/or rotate locally an object A1-A9.

In the embodiment shown in FIGS. 13-16, the primary translator 103 comprises three belts that are arranged flanked and that move in a concordant way to define the translation direction X. As shown in FIG. 14, the three belts are aligned along a direction orthogonal with respect to the translation direction X and are so arranged:
a first belt is arranged in the central portion of the resting surface 106 of the head element 102 and has a first linear extension;
a second and a third belt are arranged on the two sides opposed of the first belt, i.e. in a lateral portion of the resting surface 106 and have a second linear extension.

Optionally, the transversal linear extension of the second and third belt is lower with respect to the transversal linear extension of the first belt.

The presence of three belts shall not be considered neither necessary nor limiting. In fact, the primary translator 103 can comprise at least one between a roller or a belt, and preferably comprises a plurality of flanked rollers or belts. Preferably, they are flanked along an oblique direction, optionally orthogonal, with respect to the predefined translation direction X. The belts are substantially plane belts. An alternative and exemplary embodiment of the conveyor device 100 comprises a primary translator 103 provided with five belts flanked to each other.

The belts that compose the primary translator 103 are preferably realized by a single closed ring element, flexible and preferably elastic. Conveniently, the primary translator 103 is realised in a material with a high friction coefficient, for example in silicone or rubber or another type of polymeric material. The primary translator 103 is substantially aligned to the resting surface 106 or extends at least partially at a height higher with respect to a height at which there is the resting surface 106. This ensures sufficient sliding friction force with the object A1-A9 to allow a quick displacement, and preferably a quick acceleration in translation and/or rotation of the object A1-A9 at least partially arranged in correspondence of the relative head element 102.

The primary translator 103 can have function of primary friction element configured to retain the object A1-A9. In other terms, the grip offered by the primary translator 103 on the object to be conveyed is greater with respect to the grip offered by the resting surface 106 and by the rest of the handling surface 10. Therefore, when the head element 102 is put in rotation by the activation of the rotation actuator 104, the primary translator 103 ensures, as far as possible, that the object A1-A9 rotates integrally with the head element 102.

The supporting element 101 comprises the rotation actuator 104, a first actuator for the primary translator 103 and a second actuator for the secondary translator 105. In a preferred but non-limiting embodiment, at least one and preferably all the above-described actuators are of electrical type. The above-described actuators can for example comprise an electric stepper motor, or permanent magnet synchronous motors. In a non-limiting embodiment, such motors can be motors of brushless type, and in particular be multipolar motors.

Generally, the rotational properties (angle, speed, acceleration, of rotation) of the motors of the conveyor device 100 shall be precisely controllable; this technical characteristic is useful where it is necessary to move objects A1-A9 with a very limited and precise linear and/or rotary motion.

It is also important that the electric motor is small in size, so that it can be easily installed inside the supporting element 101.

Electric motors of brushless type have high dynamic characteristics and are also provided with constant torque up to maximum speed. It is also preferable that the electric motor is controllable in such a way as to have very high accelerations.

Previously, it has been described that the supporting element 101 is removably constrained to the head element 102, which overlies it in a direction aligned to the rotation axis Z.

Conveniently the rotation actuator 104, the first actuator and the second actuator are positioned in the supporting element 101 and conveniently transfer the motion necessary to the handling of the primary translator 103 and/or to the rotation of the head element 102 by means of motion transfer mechanisms comprising a belt and double pulley gearbox, or a bevel gear.

Having a head element 102 free from actuators is advantageous. In fact, in this way, the head element 102 is inexpensive to produce, and where damaged it can be replaced by means of disconnection with the supporting element 101 without determining a significant cost.

Furthermore, having a head element 102 free from actuators allows to keep the weight down. The lightness of the head element 102 is useful so that it can be accelerated in translation or rotation with respect to the rotation axis Z with ease, without large inertias that would determine the use of proportionally more powerful electric motors.

In a preferred, but non-limiting embodiment, the head element 102 can be produced by means of a moulding process, for example injection moulding or co-moulding.

The supporting element 101 can conveniently comprise a connector 101h configured to provide electric power to the rotation actuator 104, to the first actuator and to the second actuator. Preferably, the head element 102 has no wired connections to the supporting element 101. In an embodiment, the absence of wired connections advantageously allows a rotation of the head element 102 with respect to the supporting element 101 by more than 360°, thus over a virtually indefinite multiplicity of rotation turns. This provides a particular control flexibility, which is conversely limited where between the head element and the supporting element of known conveyor devices there is a wired connection. In the light of the above-described technical characteristic, it is clear that the head element 102 can rotate with respect to the supporting element 101 by an angle greater than 180°, or greater than 270°, or greater than 360° or multiples thereof.

Advantageously, it is also possible to adapt the size of the head element 102 with respect to the size of the supporting element 101, without having to make changes on the latter.

The conveyor device 100 can advantageously comprise a weight sensor, configured to detect if on the head element 102 rests the weight of any object or not. The weight sensor is preferably of electronic type.

The head element 102 comprises a lower ring 102b which is configured to be directly coupled to the supporting element 101. The lower ring 102b comprises a plurality of engagement pins on the supporting element 101. Alternatively, these engagement pins can be equivalently replaced by holes in correspondence thereof is arranged a respective pin of the supporting element 101.

As represented in detail in the perspective section of FIG. 16, the supporting element 101 comprises a lower portion and a higher portion, respectively indicated with the numerical references 101i and 101u.

The lower ring 102b is in particular fixed to the supporting element 101 in correspondence of the upper portion 101u thereof and is integral in rotation with the upper portion 101u on the rotation axis Z.

In a preferred, but non-limiting embodiment, the upper portion 101u of the supporting element 101 comprises a substantially planar upper surface and provided with ribs 101z for the engagement on the head element 102. The embodiment shown in the attached figures is such that the upper surface of the supporting element 101 comprises two counterposed ribs 101z. The ribs 101z are in use inserted in recesses 102r present in correspondence of the lower ring 102b of the head element 102.

The supporting element 101 can be configured to be unconstrained operatively from the head element 102 by means of a tool. In an embodiment, in correspondence of the ribs 101z can be present holes axially aligned to the rotation axis Z, for the engagement of a tool with an elongated body shape that is configured to pass through a service hole of the head element 102.

In a preferred embodiment, the entire conveyor device 100 (supporting element 101 and head element 102) is releasable from the module 2, so that in the event of mechanical and/or electronic failure, it is possible to replace the entire device to proceed, only in a second time, with the separation of the head element 102 from the supporting element 101. This technical characteristic advantageously allows to speed up the possible removal of the head element 102 that needs to be replaced, for example because damaged, in such a way as to reduce the downtime of the conveyor system.

The upper portion 101u of the supporting element 101 further comprises a lateral surface. In the embodiment shown in the attached figures, the lateral surface extends in a direction substantially orthogonal with respect to the upper surface of the upper portion 101u.

The upper portion 101u is configured to rotate with respect to the lower portion 101i. In particular, the relative rotation that can take place between these two portions takes place on the rotation axis Z. The lower portion 101i is fastened in rotation around the rotation axis Z by virtue of a constraint with the seat 20 of the corresponding module 2. Consequently, with the rotation of the upper portion 101u with respect to the lower portion 101i, due to the engagement that is present between the ribs 101 and the recesses 102r, the head element 102 is dragged in rotation around the rotation axis Z and rotates with respect to the lower portion 101i of the supporting element 101.

The lower portion 101i comprises a supporting ring 1010 that is configured to be positioned in correspondence of the second support plane 22 of the module 2. The supporting ring 1010 extends from the lateral surface of the lower portion 101i of the supporting element 101 along a substantially inclined direction, preferably substantially orthogonal with respect to the lateral surface. In an embodiment that shall not be intended as limiting, the supporting ring 1010 is preferably arranged in correspondence of an area of the lower portion 101i next to the upper portion 101u.

Clearly, the above-described configuration shall not be intended as limiting. For example, the recesses could be realised on the upper surface of the upper portion 101u of the supporting element 101, and the ribs could be realised on the basis of the head element 102. Alternatively, ribs 101z or recesses 102r could be arranged on the lateral surface of the upper portion 101u of the supporting element 101.

On the upper surface of the upper portion 101u of the supporting element 101 is present a first gear 101w of a bevel gear 101w-102w. The first gear 101w is configured to rotate around the rotation axis Y and is positioned in position centered on the upper surface.

The upper portion 101u of the supporting element 101 comprises a support 101p for a position sensor; the support 101p at least partially overlaps the first gear 101w.

As represented in FIG. 14, the head element 102 has a cavity opening at least in correspondence of a bottom area thereof; this cavity 102c allows for the partial introduction of the first gear 101w inside the volume overall defined by the head element 102.

The second gear 102w of the bevel gear 101w-102w is rotatably fixed on a lateral wall of the head element 102. The second gear 102w extends from an inner face of the lateral wall of the head element 102 facing the cavity 102c. The second gear 102w of the bevel gear 101w-102w rotates around an axis substantially orthogonal to the rotation axis Y.

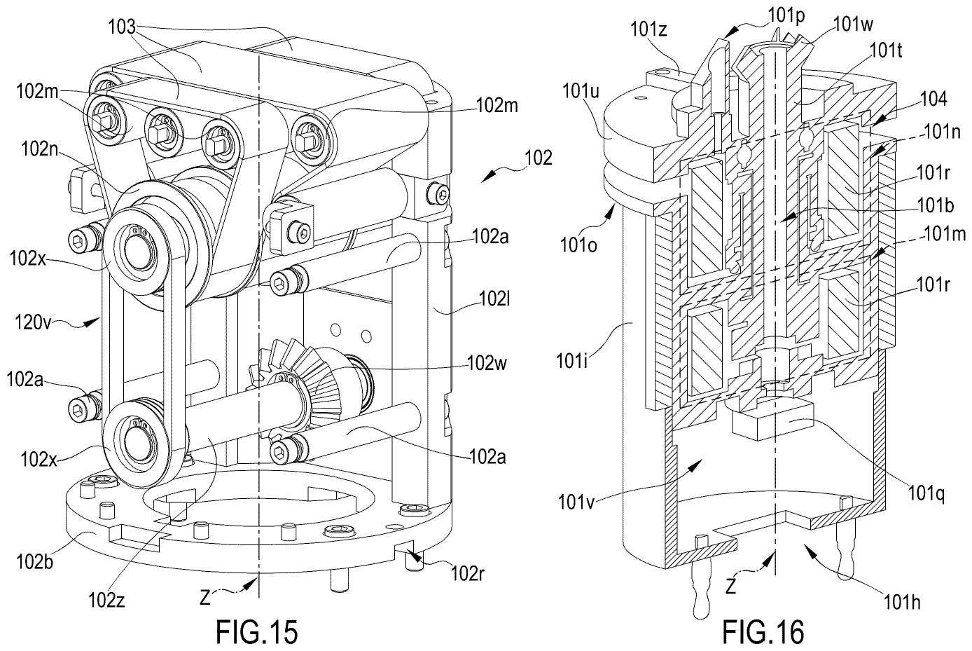

As it can be seen for example from FIG. 15, the lower ring 102b comprises a central hole-preferably circular in shape. This central hole allows the introduction of the first gear 101w of the bevel gear 101w-102w inside the cavity 102c.

The second gear 102w is connected a lay shaft 102z which is oriented in direction substantially orthogonal to the rotation axis Y, i.e. in a substantially horizontal direction. The lay shaft 102z is connected to the second gear 102w in a rotatably fixed way, and integrally rotates with the second gear 102w. A first end of the lay shaft 102z is connected to the second gear 102w; a second end of the lay shaft 102z, opposed to the first end, is connected to a first grooved pulley 102x.

In the embodiment shown in the attached figures, which is non limiting, the first grooved pulley 102x is accessible from the lateral wall 1021 of the head element 102, and is recessed in a lateral recess 120c of the lateral wall 1021 of the head element 102.

Preferably, the lateral wall 1021 has a first portion and a second portion; the first and second portion are separable, and in particular to allow an access to the cavity 102c. In the embodiment represented in the annexed figures, the first and second portion of the lateral wall 1021 have a substantially curved shape.

Spacer elements 102a are interposed between the first portion and the second portion of the lateral wall 1021. The spacer elements 102a are substantially rigid and arranged along an oblique direction, preferably orthogonal, with respect to the direction defined by the rotation axis Z. In the embodiment shown in the attached figures, the spacer elements 102a are in the form of a cylindrical bar.

A belt 120v or an equivalent flexible motion transmission element transmits a motion to a second grooved pulley 102x which is recessed too in the lateral recess 120c.

The assembly formed by the first grooved pulley 102x, the second grooved pulley 102x and the belt 120v realises a belt drive or belt.

The second grooved pulley 102x rotates about an axis substantially orthogonal to the rotation axis Z and, therefore, horizontal. In a preferred embodiment, the second grooved pulley 102x has a diameter identical to the one of the first grooved pulley 102x, so as to realise a 1:1 transmission ratio. This technical characteristic is not to be intended in an exclusively exemplary way and therefore not limiting.

The second grooved pulley 102x therefore results to be a driven pulley, while the first grooved pulley 102x results to be a driving pulley.

At least one auxiliary pulley 102n rotates integrally with the second grooved pulley 102x. The auxiliary pulley 102n is a grooved pulley too. In the embodiment shown in the attached figures, the belts that compose the primary translator 103, in the form of a flat belt, are introduced into the auxiliary pulley 102n.

Since in the embodiment shown in FIGS. 13-16 the primary translator 103 comprises three separate belts, there are three auxiliary pulleys 102n all rotating around a rotation axis substantially orthogonal to the rotation axis Z, i.e. around a substantially horizontal axis.

The head element 102 comprises further a plurality of supports 102m for the belts of the primary translator 103. In a non-limiting embodiment, these supports 102m are in form of rolling elements, in particular they are rollers. The supports 102m provide a resting surface for the part of the belts that faces the supporting surface 106 and reduce the belt deformation even under heavy weights. In other words, the supports 102m perform the function of tensioning the belts that compose the primary translator 103. The supports 102m extend substantially on a plane parallel to the first support plane 21. Preferably, the rolling elements, in particular the rollers, are arranged with their respective rotation axes significantly inclined, preferably orthogonal, with respect to the rotation axis Z.

The first gear 101w is keyed on a motion transmission shaft 101b which extends between the upper portion and the lower portion 101i of the supporting element 101. In particular, the motion transmission shaft 101b is centred in the supporting element 101, and more in particular is centred on the upper portion and the lower portion 101i of the supporting element 101.

A rotor assembly 101r of a first electric motor 101m is attached to the motion transmission shaft 101b.

A rotor assembly 101t of a second electric motor 101n is fastened to the upper portion of the supporting element 101, and drags the upper portion of the supporting element 101 in integral rotation.

The second electric motor 101n is part of the above-described rotation actuator 104. Clearly, the second electric motor 101n is independently activatable from the first electric motor 101m. The first and second electric motors 101m, 101n are separately and/or simultaneously activatable.

Preferably, the rotor assembly 101t of the second electric motor 101n is placed at a height higher (above) than the height at which the rotor assembly 101t of the first electric motor 101m is placed.

The first electric motor 101m and the second electric motor 101n are substantially coaxial and are preferably, but not limited thereto, torque motors. Torque motors are direct-drive motors: the rotor is directly connected to the loading without any intermediate elements. This technical characteristic provides compactness, rigidity and high positioning accuracy especially in changes of direction, also by virtue of the absence of play between the components. The above-described characteristics, in particular relating to the type of electric motors and the structural configuration of the motion transmission elements, provide a reduction in coupling inertia and a high positioning accuracy.

The lower portion 101i of the supporting element 101 comprises a lateral wall preferably defines a cylindrical body. The lateral wall comprises at least one engagement element 101a with the seat or recess for the supporting element 101. In the attached figures the engagement element 101a is a rib extending in a direction substantially parallel to the rotation axis Z. The engagement element 101a is inserted by a sliding in a respective recess realized in correspondence of a seat of the plurality of seats 20 of the module 2. Also in this case, the opposite situation can alternatively be present. The engagement element 101a can be a recess, for example aligned along a direction substantially parallel to the one of the rotation axis Z, and the rib can be arranged in correspondence of a seat of the plurality of seats 20 of the module 2.

A bottom zone of the lower portion 101i can advantageously comprise a hole for the passage of electrical connection cables and a compartment 101v for housing, for example, one or more sensors.

In a preferred, but non-limiting embodiment, a feedback sensor 101q is coupled to the motion transmission shaft 101b. In an embodiment, the feedback sensor 101q is a magnetic sensor, for example a Hall effect sensor. A magnet of the feedback sensor 101q is fixed in rotation with the motion transmission shaft 101b. On the basis of the relative position between the magnet of the sensor (relative rotation) and a blade sensitive element, it is possible to precisely determine the angle of rotation of the magnet and thus of the motion transmission shaft 101b with respect to a reference angular position. The feedback sensor 101q is operatively-preferably electrically and/or optically-connected to the controlling module CM. The feedback sensor 101q returns to the controlling module CM a signal proportional to the rotation of the motion transmission shaft 101b. This signal can advantageously be used to correct in feedback the movement of the rotor of the first electric motor 101m.

Preferably, all the conveyor devices 100 installed in the module 2, and thus also in the loading station 1, are all of the same size. Alternatively, in an embodiment, part of the plurality of conveyor devices 100 can have a first size and a further part of the plurality of conveyor devices 100 can have a second size, different from the first size. Finally, it is noted that the previously described process P and the loading station 1 can also be executed/configured to carry out a substantially opposite procedure, i.e. of unloading at least one object A1-A9 from a conveyor device 200.

It results in particular that the process herein described is a process P that can be reversible in the modes and options already described. Furthermore, the loading station 1 can be considered a station of unloading of at least one object from a conveyor apparatus 200.

This allows a significant operational flexibility, in particular since it is possible to make the station herein described configured to carry out a bidirectional process of loading and unloading of objects A1-A9 from the conveyor apparatus 200, optionally following equal and opposite steps, in particular by being able to define a plurality of parallel flows (also simultaneously parallel) of loading and unloading of objects A1-A9 in the modes herein described.

The station 1 and the process P so far described can also be destined to carry out an opposite operation with respect to the one herein described, i.e. the unloading of one or more objects A1-A9 from a conveyor apparatus 200. In order not to cause an excessive lengthening of the present description, it is intended that a particular embodiment of the station and of the process can define an operation and steps exactly opposite to those previously described in the description and/or in the summary relating to the loading of one or more objects onto the conveyor apparatus.

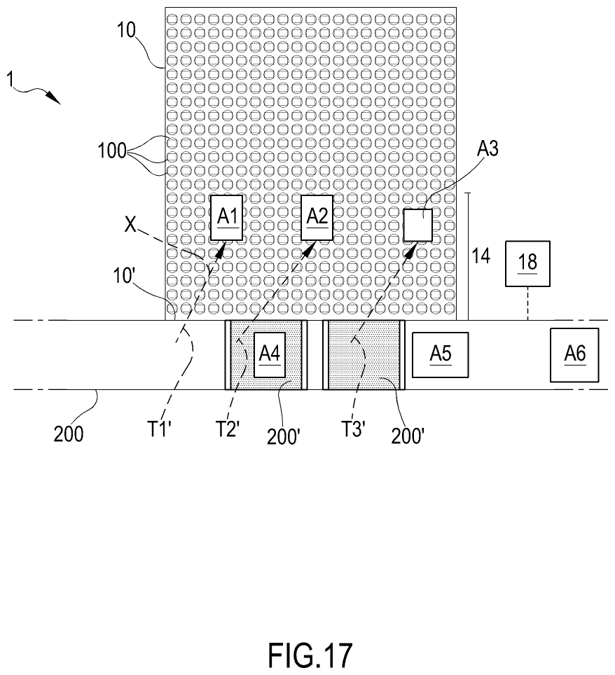

With reference to FIG. 17, from the plurality of pre-defined loading areas 200′, a plurality of extraction trajectories T1′-T3′ of a corresponding plurality of objects A1-A3 from the conveyor apparatus are identified.

The extraction of at least one object A1-A9 takes place according to a process P of unloading of objects A1-A9 from the conveyor apparatus 200, in particular from the conveyor belt.

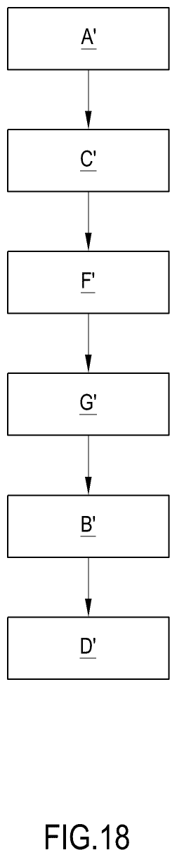

Referring also to FIG. 18, the present disclosure further shows a process P of unloading of objects from a conveyor apparatus 200, which firstly comprises a step A′) of arranging a loading station 1 defining the handling surface 10.

Subsequently, the process provides for a step C′) of identifying at least one object A1-A9 on the conveyor apparatus 200, and in particular detecting a plurality of objects A1-A9 arranged simultaneously on the conveyor apparatus 200, in one or more loading areas 200′of the conveyor apparatus.

The process provides then for a step F) which provides for calculating an extraction trajectory T1′-T3′ that defines an extraction path of the objects A1-A3 from the conveyor apparatus 200. Similarly to what has been described in the loading process P, each trajectory is defined individually for each object, by means of an electronic calculation performed by the controlling module CM.

Furthermore, the extraction trajectory T1′-T3′ of each object is calculated in accordance with the forward direction V of the conveyor apparatus, to define a extraction path provided with a particular inclination defined for each object. Thus, also step F') provides for the definition of a customised trajectory for each object, by virtualising an unloading line from the conveyor apparatus 200 that allows to define a customised trajectory for each object. Optionally, step F′) can be executed in such a way as to have a straight line.

Still optionally, step F′) can comprise a definition of an extraction speed for the corresponding extraction trajectory T1′-T3′. This extraction speed can conveniently be electronically calculated, as in the case of the insertion speed, by the controlling module CM in accordance with the handling speed (electronic handling data) of the predefined loading area 200′. It therefore results that the extraction process-in a manner entirely similar to the previously described loading process P-also takes place in synchrony with the conveyor apparatus 200 and thus in substantial temporal simultaneity with a handling of the loading area 200′with respect to the handling surface.

In analogy to what has been described for the insertion, the objects extracted from the conveyor apparatus 200 can be extracted with trajectories (handling paths) and have, on the handling surface 10, variable speeds and/or variable inclinations.

Consequently, the controlling module CM can be configured to define at least one first speed and second speed, and/or at least a first inclination and second inclination, of an extraction path of at least an object A1-A9 from the conveyor apparatus. In analogy to what has been described for the insertion, the first speed and/or inclination can be associated and/or present on a first portion of the handling surface 10 and the second speed and/or inclination can be present on a second portion of the handling surface 10.

Furthermore, in analogy to what has been described for the insertion, the objects extracted from the conveyor apparatus 200 can be extracted with trajectories (handling paths) that cross at least once.

At this point, the process comprises a step G′) of insertion of at least one object A1-A9 on the handling surface 10 in accordance with the extraction trajectory T1′-T3′ previously defined. Such step determines then (step B′) the loading of the at least one object A1-A9 on the handling surface 10.

Step G′), that as previously describe is managed by the controlling module CM, can provide preferably for excluding the collision of two or more objects where their handling paths cross.

Preferably, but not limited thereto, the process comprises a step D) that provides for a rotation of the at least one object A1-A9 for reaching a predefined rotation.

A particular embodiment of the processes and of the system herein described provides for a “fault tolerant” mode, wherein, following the detection of a malfunction of one or more of the conveyor devices 100 that are affected by the handling trajectory of the at least one object A1-A9, the controlling module CM executes, preferably in an automatic way, a step of electronically recalculation of the insertion trajectory T1-T3 and/or of the extraction trajectory T1′-T3′ of the at least one object A1-A9, in order to define an auxiliary insertion and/or extraction trajectory for said at least one object, excluding the at least one malfunctioning conveyor device; it results that the auxiliary insertion and/or extraction trajectory for the at least one object A1-A9 involves exclusively functioning conveyor devices 100.

The invention is not limited to the embodiments of the figures; for this reason, the numbers and reference signs in the claims are provided for the sole scope of increasing the intelligibility thereof, and do not have limiting character.

It is finally clear that to the object of the present disclosure can be applied additions, modifications or variants, obvious for the skilled person, without for this departing from the scope of protection provided by the annexed claims.

1. A process for loading objects on a conveyor apparatus, in particular on a conveyor belt, comprising the following steps:
A) arranging a loading station defining a handling surface operatively associated to said conveyor apparatus;
B) loading at least one object on said handling surface;
C) detecting said at least one object on said handling surface;
F) defining an insertion trajectory on said conveyor apparatus of said at least one object, said insertion trajectory being defined individually for each object in accordance with a condition of said conveyor apparatus and/or with a number of objects present on said handling surface;
G) inserting said at least one object on said conveyor apparatus in accordance with said insertion trajectory.

2. The process according to claim 1,
wherein said step F) provides, for each object, a definition of an insertion path ending on said conveyor apparatus, said insertion path having a respective inclination with respect to a forward direction of said conveyor apparatus, wherein said inclination is adjusted in accordance with a destination position of said at least one object on said conveyor apparatus;
and/or wherein said step F) provides, for each object, a definition of an insertion speed of said insertion trajectory;
and/or wherein said insertion speed is defined, for each object, in accordance with said inclination of the respective insertion path, said insertion speed being defined in a temporally varying way and/or said inclination being temporally varying,
wherein the method comprises further the following step:
D) orienting said at least one object according to a predefined orientation, or maintaining a pre-set orientation of said at least one object, said predefined or pre-set orientation being defined along an axis tilted with respect to said handling surface or at least locally orthogonal with respect to said handling surface.

3. The process according to claim 1, wherein, in said step B), a plurality of objects can be loaded simultaneously on the handling surface, said step F) providing the definition of a plurality of insertion trajectories, one for each object of the plurality of objects, said plurality of insertion trajectories differing from each other;
and/or wherein said plurality of insertion trajectories have insertion paths different from each other and/or inclinations different from each other and/or insertion speeds different from each other;
and/or wherein said step F) provides that the insertion trajectory of each object comprises at least one straight section;
step F) providing that the insertion trajectory of each object comprises at least one curvilinear section.

4. The process according to claim 1, comprising a step E) of assessing at least one status parameter of said at least one object, said step E) providing for the execution of at least one of the following activities:
a measurement of a weight of said at least one object; and/or
a measurement of a volume of said at least one object; and/or
a scanning of an identification code, of said at least one object;
and/or wherein said step D) provides a rotation of said at least one object for reaching said predefined orientation, said rotation of said at least one object taking place around a respective rotation axis, said rotation axis being perpendicular to said handling surface.

5. The process according to claim 1, wherein said step A) provides that the handling surface of the loading station is defined at least partially by a plurality of conveyor devices arranged according to a planar matrix, said plurality of conveyor devices being homogeneously distributed on at least part of an extension of said handling surface;
and/or wherein each conveyor device of the plurality of conveyor devices is configured to be activated in order to locally control a translation of said at least one object on the handling surface at least during the execution of step G) and/or a rotation of said at least one object, said rotation taking place around a respective rotation axis, orthogonal to the handling surface at least during the execution of said step D);
wherein the plurality of conveyor devices is configured to singularize two or more objects at least partially overlapping and respectively arranged at heights different from each other with respect to the handling surface.

6. The process according to claim 1, wherein said step G) comprises inserting said at least one object on a predefined loading area of said conveyor apparatus, said loading area being movable with respect to said handling surface.

7. The process according to claim 6, wherein said step G) comprises moving said at least one object on said handling surface in accordance with said insertion trajectory,
wherein said step G) comprises moving said at least one object on said handling surface in accordance with said insertion trajectory in synchrony with said conveyor apparatus and/or in substantial temporal simultaneity with a handling of said loading area with respect to said handling surface so that said at least one object when in substantial correspondence of a peripheral portion of said handling surface is in correspondence of said predefined loading area.

8. The process according to claim 1, comprising receiving handling electronic data of said predefined loading area from said conveyor apparatus, and wherein said step G) comprises moving said at least one object on said handling surface in accordance with said insertion trajectory and in accordance with said handling electronic data,
said process comprising defining and/or adapting said insertion trajectory in accordance with said handling electronic data.

9. The process according to claim 1, comprising the following steps:
F′) defining an extraction trajectory of said at least one object from said conveyor apparatus, said extraction trajectory being defined individually for each object present on said conveyor apparatus in accordance with said condition of said conveyor apparatus and/or with a number of objects present on said handling surface;
G′) extracting said at least one object from said conveyor apparatus in accordance with said extraction trajectory.

10. The process according to claim 1, comprising detecting at least one specific conveyor device that is malfunctioning, among the plurality of conveyor devices of the handling surface, and comprising defining an auxiliary insertion trajectory, for an insertion of said at least one object on said conveyor apparatus, and/or an auxiliary extraction trajectory, for an extraction of said at least one object from said conveyor apparatus,
said auxiliary insertion trajectory differing from said insertion trajectory and/or said auxiliary extraction trajectory differing from said extraction trajectory;
said auxiliary insertion trajectory and/or said auxiliary extraction trajectory excluding said at least one specific conveyor device that is malfunctioning.

11. A loading station for loading objects on a conveyor apparatus, in particular on a conveyor belt, defining a handling surface operatively associated to said conveyor apparatus, said handling surface comprising:
a loading portion configured to receive at least one object;
a controlling portion configured to identify said at least one object on said handling surface;
an inserting portion configured to insert said at least one object on said conveyor apparatus according to a respective insertion trajectory;
said loading station comprising further a controlling module, operatively associated at least to said controlling portion and said inserting portion; said controlling module being configured to define said insertion trajectory in accordance with a condition of said conveyor apparatus (200) and/or with a number of objects present on the handling surface.

12. The loading station according to claim 11, wherein said handling surface extends away from said conveyor apparatus starting from a proximal end, contiguous with the conveyor apparatus, up to a distal end, said loading portion comprising said distal end and said inserting portion comprising said proximal end;
and/or wherein said handling surface extends away from said conveyor apparatus along a loading direction, said loading direction being tilted, or perpendicular, with respect to a forward direction of said conveyor apparatus;
and/or wherein said loading station comprises at least one controlling sensor, operatively connected to said controlling portion and configured to detect said at least one object in said controlling portion, said at least one controlling sensor being configured to calculate a position of said at least one object in said controlling portion,
wherein said loading station comprises an orienting portion configured to orient said at least one object according to a predefined orientation or to maintain a pre-set orientation of said at least one object, said predefined or pre-set orientation being defined along an axis tilted with respect to said handling surface or at least locally orthogonal with respect to said handling surface;
said controlling module being operatively associated to said orienting portion.

13. The loading station according to claim 11, wherein said controlling module is configured to define an insertion path ending on said conveyor apparatus, said insertion path having a respective inclination with respect to a forward direction of said conveyor apparatus, wherein said inclination is adjusted in accordance with a destination position of said at least one object on said conveyor apparatus.

14. The loading station according to claim 11, or wherein said handling surface is defined at least partially by a plurality of conveyor devices arranged according to a planar matrix, said plurality of conveyor devices being homogeneously distributed on at least part of an extension of said handling surface;
and/or wherein each conveyor device of the plurality of conveyor devices is configured to be activated in order to locally control a translation of said at least one object on the handling surface;
and/or wherein a portion of said plurality of conveyor devices defining said orienting portion is configured to be activated in order to locally control a rotation of said at least one object, said rotation occurring around a respective rotation axis orthogonal to said handling surface;
wherein the plurality of conveyor devices is configured to singularize two or more objects at least partially overlapping and respectively arranged at heights different from each other with respect to the handling surface.

15. The loading station according to claim 11, wherein said controlling module is configured to cause an insertion of said at least one object on a predefined loading area of said conveyor apparatus, said loading area being movable with respect to said handling surface

16. The loading station according to claim 11, wherein said controlling module is configured to cause an insertion of said at least one object on said loading area in accordance with said insertion trajectory,
wherein said controlling module is configured to cause an insertion of said at least one object on said loading area in accordance with said insertion trajectory in synchrony with said conveyor apparatus and/or in substantial temporal simultaneity with a handling of said loading area with respect to said handling surface so that said at least one object, when in substantial correspondence of a peripheral portion of said handling surface, is in correspondence of said predefined loading area.

17. The loading station according to claim 11, wherein said controlling module is configured to receive handling electronic data of said predefined loading area from said conveyor apparatus and to cause an insertion of said at least one object on said predefined loading area in accordance with said insertion trajectory and in accordance with said handling electronic data,
wherein said controlling module is configured to define and/or adapt said insertion trajectory in accordance with said handling electronic data.

18. The loading station according to claim 11, to wherein said handling surface comprises a weighing portion configured to measure a weight of said at least one object, said weighing portion comprising at least one weight sensor operatively connected to said controlling module;
and/or wherein said handling surface comprises a volume assessment portion configured to measure a volume of said at least one object, said volume assessment portion comprising at least one optical sensor operatively connected to said controlling module;
and/or wherein said handling surface comprises a reading portion configured for a scanning of at least one identification code of said at least one object, said reading portion comprising an optical reader operatively connected to said controlling module.

19. The loading station according to claim 11, wherein the loading portion is configured to receive simultaneously a plurality of objects;
and/or wherein the controlling portion is configured to simultaneously identify said plurality of objects on said handling surface;
and/or wherein the orienting portion is configured to simultaneously orient the plurality of objects according to respective predefined orientations;
and/or wherein the inserting portion is configured to simultaneously insert said plurality of objects on said conveyor apparatus according to a plurality of insertion trajectories, each insertion trajectory of said plurality of insertion trajectories being calculated by said controlling module in a customized way for each object of the plurality of objects in accordance with said condition of said conveyor apparatus and/or with the number of objects present on the handling surface

20. The loading station according to claim 11, to further configured to carry out an unloading of said at least one object from said conveyor apparatus;
wherein said inserting portion is also configured to receive said at least one object from said conveyor apparatus and to introduce it in handling on said handling surface according to a respective extraction trajectory;
and wherein said controlling module is configured to define said extraction trajectory in accordance with a condition of said conveyor apparatus and/or with a number of objects present on the handling surface.

21. (canceled)
